(19) United States
(12) Patent Application Publication
(10) Pub. No.: US 2024/0400761 A1
(43) Pub. Date: Dec. 5, 2024

(54) HEAT-CURABLE RESIN, COMPOSITION, UNCURED MOLDED OBJECT, PARTLY CURED MOLDED OBJECT, CURED MOLDED OBJECT, AND METHOD FOR PRODUCING HEAT-CURABLE RESIN

(71) Applicant: KANEKA CORPORATION, Osaka (JP)

(72) Inventor: Hideki Yamamoto, Osaka (JP)

(73) Assignee: KANEKA CORPORATION, Osaka (JP)

(21) Appl. No.: 18/694,900

(22) PCT Filed: Oct. 12, 2022
(86) PCT No.: PCT/JP2022/037971

§ 371 Date: Mar. 22, 2024

(30) Foreign Application Priority Data
Oct. 12, 2021 (JP) 2021-167624
Nov. 9, 2021 (JP) 2021-182762
Nov. 26, 2021 (JP) 2021-191679
Feb. 10, 2022 (JP) 2022-019839

(51) Int. Cl. C08G 73/06

(52) U.S. Cl. CPC C08G 73/06

(57) ABSTRACT

Provided are a benzoxazine-based resin which is excellent in plasticity before curing and/or decomposition temperature and toughness before and after curing and a method for producing the benzoxazine-based resin. A thermosetting resin in accordance with an aspect of the present disclosure is a thermosetting resin which has a benzoxazine ring structure in a main chain, the thermosetting resin having: an aromatic group derived from a bifunctional phenol compound (A); and a linear alkylene group derived from an aliphatic diamine compound (B); and optionally a (poly)oxyalkylene group derived from a (poly)oxyalkylenediamine compound (C).

### TECHNICAL FIELD

The present disclosure relates to a thermosetting resin which has a benzoxazine ring structure in a main chain and a method for producing the thermosetting resin.

### BACKGROUND ART

It is known that a benzoxazine compound cures without generating a volatile component, in a case where a benzoxazine ring undergoes, by heat or the like, ring opening polymerization and a reaction. Therefore, a thermosetting resin that contains, as a main component, a low molecular weight compound or a polymer each of which has a benzoxazine structure has various advantages such as a low dielectric constant and low cure shrinkage, in addition to the basic characteristics, such as heat resistance, water resistance, chemical resistance, mechanical strength, and long-term reliability, of a thermosetting resin, and has been attracting attention. Here, although a low molecular weight compound which has a benzoxazine structure is easy to produce, the low molecular weight compound has characteristics of, for example, being poor in handleability, for example, being brittle in a solid state before curing. Although a polymer which has a benzoxazine structure is good in handleability in a solid state before curing, the polymer has characteristics of, for example, being difficult to produce. Therefore, different polymers are used, depending on the characteristics of the polymers.

Patent Literature 1 discloses a method of producing a thermosetting resin which has a dihydrobenzoxazine ring structure in a main chain, by reacting (i) a bifunctional phenol compound, (ii) an aliphatic diamine or an aromatic diamine, and (iii) an aldehyde compound.

### CITATION LIST

### Patent Literature

### Patent Literature 1

Japanese Patent Application Publication Tokukai No. 2008-291070

### SUMMARY OF INVENTION

### Technical Problem

However, a conventional benzoxazine-based resin as stated above has room for further improvement, from the viewpoint of realization of a benzoxazine-based thermosetting resin which is excellent in plasticity before curing. Moreover, the conventional benzoxazine-based resin has room for improvement, in terms of a decomposition temperature and toughness before and after curing.

An object of an aspect of the present disclosure is to realize a benzoxazine-based thermosetting resin which is excellent in plasticity before curing and a method for producing the benzoxazine-based thermosetting resin. Moreover, an object of another aspect of the present disclosure is to provide a benzoxazine-based resin which is excellent in decomposition temperature and toughness before and after curing and a method for producing the benzoxazine-based resin.

### Solution to Problem

In order to attain the above object, a thermosetting resin in accordance with an aspect of the present disclosure has, in a main chain, a benzoxazine ring structure represented by a general formula (I):

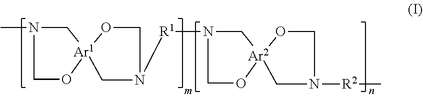

[wherein:
Ar¹ and Ar² each independently represent a tetravalent aromatic group that is derived from a bifunctional phenol compound (A), and may be identical to or different from each other;
n represents an integer of 0 or more;
in a case where n=0, R¹ represents a linear alkylene group that is derived from an aliphatic diamine compound (B) and that has 8 to 12 carbon atoms, and, in a case where n=1 or more, R¹ represents a linear alkylene group that is derived from the aliphatic diamine compound (B) and that has 6 to 12 carbon atoms;
R² represents a (poly)oxyalkylene group that is derived from a (poly)oxyalkylenediamine compound (C);
in the case where n=0, at least one of two termini of the main chain is a group that is derived from a monofunctional phenol compound (E) and that is represented by a general formula (II) below, and the two termini may be identical to or different from each other;
in the case where n=0, m represents an integer of 2 or more, and, in the case where n=1 or more, m represents an integer of 1 or more; and
a repeating unit indicated by m and a repeating unit indicated by n are repeated randomly, repeated as blocks, or copolymerized in an alternating manner],

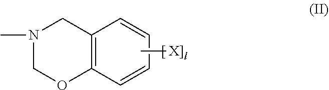

[wherein:
X represents a hydrogen atom or an organic group that has 1 to 20 carbon atoms; and
l represents an integer of 0 to 3].

In order to attain the above object, a thermosetting resin in accordance with an aspect of the present disclosure is a thermosetting resin which has a benzoxazine ring structure in a main chain, wherein
an uncured molded product that is obtained by molding the thermosetting resin and that has a degree of cure of less than 1% or a partially cured molded product that is obtained by curing the thermosetting resin and that has a degree of cure of 1% to 99% has thermoplastic remoldability and toughness,
the thermoplastic remoldability refers to a property in which, after the uncured molded product or the partially cured molded product is deformed in any shape, the uncured molded product or the partially cured molded product is restored to a shape before deformation, by heating at not higher than 200° C.,
the toughness refers to a property in which a break or a crack does not occur in the uncured molded product or the partially cured molded product before and after the heating, and
the uncured molded product or the partially cured molded product has repetitive thermoplasticity that is a property in which the thermoplastic remoldability and the toughness are maintained even in a case where the deformation and the heating are carried out once or more.

In order to attain the above object, a method for producing a thermosetting resin in accordance with an aspect of the present disclosure is a method for producing a thermosetting resin which has a benzoxazine ring structure in a main chain, including:
a step (s1) of reacting a bifunctional phenol compound (A), an aliphatic diamine compound (B), and an aldehyde compound (D);
optionally a step (s2) of reacting the bifunctional phenol compound (A), a (poly)oxyalkylenediamine compound (C), and the aldehyde compound (D); and
optionally a step (s3) of reacting a monofunctional phenol compound (E), wherein:
in a case where the method does not include the step (s2), the method includes the step (s3);
in a case where the method includes the step (s2), the aliphatic diamine compound (B) is an aliphatic diamine that has a linear alkylene group having 6 to 12 carbon atoms, and, in a case where the method does not include the step (s2), the aliphatic diamine compound (B) is an aliphatic diamine that has a linear alkylene group having 8 to 12 carbon atoms; and
the (poly)oxyalkylenediamine compound (C) has a (poly)oxyethylene group and/or a (poly)oxypropylene group.

### Advantageous Effects of Invention

According to an aspect of the present disclosure, it is possible to realize a benzoxazine-based thermosetting resin which is excellent in plasticity before curing. Moreover, according to an aspect of the present disclosure, it is possible to provide a benzoxazine-based resin which is excellent in decomposition temperature and toughness before and after curing and a method for producing the benzoxazine-based resin.

### BRIEF DESCRIPTION OF DRAWING

FIG. 1 is a graph showing DMA curves of various films.

### DESCRIPTION OF EMBODIMENTS

### [1. Thermosetting Resin]

The following description will discuss examples of embodiments of the present disclosure in detail. The present disclosure is, however, not limited to the embodiments. Note that a numerical range expressed as “A to B” means “not less than A and not more than B”, unless otherwise specified in this specification. Note also that, in the present disclosure, a thermosetting resin which is not heated at all may be referred to as “uncured resin”.

Patent Literature 1 discloses, in examples, Bz which has a structural unit derived from an aliphatic diamine having 6 carbon atoms (hexamethylenediamine) and of which a terminus/termini is/are capped with phenol (hereinafter, referred to as C6Bz). However, the inventors of the present disclosure found that C6Bz has room for further improvement, from the viewpoint of plasticity before curing.

According to an aspect of the present disclosure, the inventors of the present disclosure found that a benzoxazine-based thermosetting resin which is excellent in plasticity before curing is obtained by introducing, into a benzoxazine structure, a structural unit that is derived from an aliphatic diamine having 8 to 12 carbon atoms. Moreover, according to an aspect of the present disclosure, the inventors of the present disclosure found that a benzoxazine-based thermosetting resin which is excellent in decomposition temperature and toughness before and after curing is obtained by introducing, into a benzoxazine structure, a structural unit that is derived from an aliphatic diamine having 6 to 12 carbon atoms and a structural unit that is derived from a (poly)oxyalkylenediamine compound. Furthermore, according to the thermosetting resin, it is possible to obtain an uncured molded product which has thermoplasticity even before curing. That is, the thermosetting resin can be said to be a thermosetting type thermoplastic benzoxazine.

The thermosetting resin of the present disclosure has, in a main chain, a benzoxazine ring structure represented by the following general formula (I). In this specification, the thermosetting resin which has the benzoxazine ring structure is also referred to as “benzoxazine resin”.

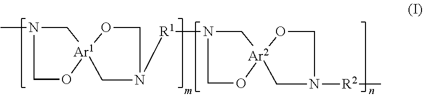

[wherein:
Ar¹ and Ar² each independently represent a tetravalent aromatic group that is derived from a bifunctional phenol compound (A), and may be identical to or different from each other;
n represents an integer of 0 or more;
in a case where n=0, R¹ represents a linear alkylene group that is derived from an aliphatic diamine compound (B) and that has 8 to 12 carbon atoms, and, in a case where n=1 or more, R¹ represents a linear alkylene group that is derived from the aliphatic diamine compound (B) and that has 6 to 12 carbon atoms;
R² represents a (poly)oxyalkylene group that is derived from a (poly)oxyalkylenediamine compound (C);
in the case where n=0, at least one of two termini of the main chain is a group that is derived from a monofunctional phenol compound (E) and that is represented by a general formula (II) below, and the two termini may be identical to or different from each other;
in the case where n=0, m represents an integer of 2 or more, and, in the case where n=1 or more, m represents an integer of 1 or more; and
a repeating unit indicated by m and a repeating unit indicated by n are repeated randomly, repeated as blocks, or copolymerized in an alternating manner.]

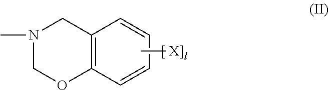

[wherein:
X represents a hydrogen atom or an organic group that has 1 to 20 carbon atoms; and
l represents an integer of 0 to 3.]

In the general formula (I), Ar¹ and Ar² each independently represent the tetravalent aromatic group that is derived from the bifunctional phenol compound (A). The bifunctional phenol compound (A) is suitably one that has a structure in which an OH group thereof and an ortho position with respect to the OH group can be incorporated into a benzoxazine ring.

Examples of the bifunctional phenol compound (A) include biphenol compounds, dihydroxydiphenylether compounds, dihydroxydiphenylmethane compounds (including derivatives, the same applies to the following compounds), dihydroxydiphenylethane compounds, dihydroxydiphenylpropane compounds, dihydroxydiphenylbutane compounds, dihydroxydiphenylcycloalkane compounds (e.g., dihydroxydiphenylcyclohexane compound), dihydroxydiphenylketone compounds, dihydroxydiphenylfluorene compounds, dihydroxydiphenylbenzene compounds, and other dihydroxydiphenyl compounds (another name: bisphenol compounds).

In the general formula (I), in the case where n=0, examples of the bifunctional phenol compound (A) include biphenol compounds, dihydroxydiphenylether compounds, dihydroxydiphenylmethane compounds (including derivatives, the same applies to the following compounds), dihydroxydiphenylethane compounds, dihydroxydiphenylpropane compounds, dihydroxydiphenylbutane compounds, dihydroxydiphenylcycloalkane compounds, dihydroxydiphenylketone compounds, dihydroxydiphenylfluorene compounds, dihydroxydiphenylbenzene compounds, and other dihydroxydiphenyl compounds.

In the general formula (I), in the case where n=1 or more, examples of the bifunctional phenol compound (A) include biphenol compounds, dihydroxydiphenylether compounds, dihydroxydiphenylmethane compounds, dihydroxydiphenylethane compounds, dihydroxydiphenylpropane compounds, dihydroxydiphenylbutane compounds, dihydroxydiphenylcycloalkane compounds, dihydroxydiphenylketone compounds, dihydroxydiphenylfluorene compounds, dihydroxydiphenylbenzene compounds, and other dihydroxydiphenyl compounds.

The biphenol compounds include 4,4′-biphenol and 2,2′-biphenol.

The dihydroxydiphenylether compounds include 4,4′-dihydroxydiphenylether and 2,2′-dihydroxydiphenylether.

The dihydroxydiphenylmethane compounds include bis(4-hydroxyphenyl)diphenylmethane, bis(4-hydroxyphenyl)methane (another name: 4,4′-dihydroxydiphenylmethane, common name: bisphenol F), and 2,2′-dihydroxydiphenylmethane.

The dihydroxydiphenylethane compounds include 1,1-bis(4-hydroxyphenyl)-1-phenylethane and 1,1-bis(4-hydroxyphenyl)ethane (common name: bisphenol E).

The dihydroxydiphenylpropane compounds include 2,2-bis(4-hydroxyphenyl)propane (common name: bisphenol A or BPA), 2,2-bis(4-hydroxyphenyl)hexafluoropropane, 2,2-bis(3-methyl-4-hydroxyphenyl)propane, 2,2-bis(4-hydroxy-3-isopropylphenyl)propane, 5,5′-(1-methylethylidene)-bis[1,1′-(bisphenyl)-2-ol]propane, 1,1-bis(4-hydroxyphenyl)propane, and 1,1-bis(4-hydroxyphenyl)-2-methylpropane.

The dihydroxydiphenylbutane compounds include 1,1-bis(4-hydroxyphenyl)butane and 2,2-bis(4-hydroxyphenyl)butane (common name: bisphenol B).

The dihydroxydiphenylcycloalkane compounds include 1,1-bis(4-hydroxyphenyl)-3,3,5-trimethylcyclohexane, 1,1-bis(4-hydroxyphenyl)cyclohexane (bisphenol Z), and 1,1-bis(4-hydroxyphenyl)cyclopentane.

The dihydroxydiphenylketone compounds include 4,4′-dihydroxybenzophenone.

The dihydroxydiphenylfluorene compounds include 9,9-bis(4-hydroxyphenyl)fluorene.

The dihydroxydiphenylbenzene compounds include 1,3-bis(4-hydroxyphenoxy)benzene and 1,4-bis(3-hydroxyphenoxy)benzene.

The other dihydroxydiphenyl compounds include bis(4-hydroxyphenyl)-2,2-dichloroethylene, bis(4-hydroxyphenyl)sulfone, 1,3-bis(2-(4-hydroxyphenyl)-2-propyl)benzene, 1,4-bis(2-(4-hydroxyphenyl)-2-propyl)benzene, 4,4′-[1,3-phenylenebis(1-methyl-ethylidene)]bisphenol (“bisphenol M”, manufactured by Mitsui Chemicals, Inc.), and 4,4′-[1,4-phenylenebis(1-methyl-ethylidene)]bisphenol (“bisphenol P”, manufactured by Mitsui Chemicals, Inc.).

Among these compounds, 4,4′-dihydroxydiphenylether, bis(4-hydroxyphenyl)methane, 2,2-bis(4-hydroxyphenyl)propane, and the like are preferable, and 2,2-bis(4-hydroxyphenyl)propane is more preferable.

In the general formula (I), R¹ represents a bivalent linear alkylene group that is derived from the aliphatic diamine compound (B) and that has 8 to 12 carbon atoms (in the case where n=0) or 6 to 12 carbon atoms (in the case where n=1 or more). That is, the aliphatic diamine compound (B) include diamine compounds each of which has a linear alkylene group having 8 to 12 carbon atoms (in the case where n=0) or 6 to 12 carbon atoms (in the case where n=1 or more). In the former case, preferable is a diamine compound that has a saturated hydrocarbon group which has a main chain skeleton having 8 to 12 carbon atoms, for example, 1,8-octanediamine (octamethylenediamine), 1,9-nonanediamine (nonamethylenediamine), 1,10-decanediamine (decamethylenediamine), 1,11-undecanediamine (undecamethylenediamine), or 1,12-dodecanediamine (dodecamethylenediamine). In the latter case (in the case where n=1 or more), preferable is a diamine compound that has a linear alkylene group having 6 carbon atoms, for example, 1,6-hexanediamine (hexamethylenediamine).

In the general formula (I), R² represents a bivalent (poly)oxyalkylene group that is derived from the (poly)oxyalkylenediamine compound (C) having a (poly)oxyalkylene skeleton and two amino group termini. In this specification, a (poly)oxyalkylene group includes a monooxyalkylene group (composed of one oxyalkylene group) and a polyoxyalkylene group (containing a plurality of oxyalkylene groups). The (poly)oxyalkylenediamine compound (C) preferably has a (poly)oxyethylene group and/or a (poly)oxypropylene group, as the (poly)oxyalkylene group. The (poly)oxyalkylenediamine compound (C) include Jeffamine D-230, Jeffamine D-400, Jeffamine D-2000, and Jeffamine D-4000 of Jeffamine (registered trademark) D-series. In particular, Jeffamine D-2000 is preferable. The thermosetting resin of the present disclosure contains the bivalent (poly)oxyalkylene group derived from the (poly)oxyalkylenediamine compound. This makes it possible to increase the toughness of the thermosetting resin before and after curing.

In order to synthesize the thermosetting resin of the present disclosure, an aldehyde compound (D) may be used. The aldehyde compound (D) is not limited in particular, but is preferably formaldehyde. The formaldehyde can be used in the form of paraformaldehyde, which is a polymer of the formaldehyde, formalin, which is an aqueous solution of the formaldehyde, or the like.

The monofunctional phenol compound (E) is not limited in particular, but is preferably phenol, o-cresol, m-cresol, p-cresol, p-tert-butylphenol, p-octylphenol, p-cumylphenol, dodecylphenol, o-phenylphenol, p-phenylphenol, 1-naphthol, 2-naphthol, m-methoxyphenol, p-methoxyphenol, m-ethoxyphenol, p-ethoxyphenol, 3,4-dimethylphenol, 3,5-dimethylphenol, or the like. Among these compounds, phenol is preferable.

In the general formula (I), m is a polymerization degree, and represents an integer of 1 or more. From the viewpoint of improving mechanical properties before and after curing, m is preferably 2 or more, more preferably 3 or more, and even more preferably 5 or more. From the viewpoint of maintaining fluidity during molding, m is preferably 500 or less, more preferably 300 or less, even more preferably 200 or less, and particularly preferably 100 or less.

In the general formula (I), n is a polymerization degree, and represents is an integer of 0 or more. From the viewpoint of improving plasticity before curing, n is preferably 0. From the viewpoint of improving the mechanical properties before and after curing, n is preferably 1 or more, more preferably 2 or more, even more preferably 3 or more, and particularly preferably 5 or more. From the viewpoint of maintaining the fluidity during molding, n is preferably 500 or less, more preferably 300 or less, even more preferably 200 or less, and particularly preferably 100 or less.

In the case where n=1 or more, a ratio between m and n is preferably n/m=1/0.1 to 1/100. In a case where the ratio between m and n falls within the above range, it is possible to obtain the thermosetting resin which is excellent in decomposition temperature and toughness before and after curing.

The thermosetting resin of the present disclosure may contain another structure of the benzoxazine ring structure represented by the general formula (I). For example, the thermosetting resin may have a structure derived from a monocyclic phenol compound for capping a terminus/termini of the structure represented by the general formula (I). The thermosetting resin of the present disclosure may contain a structure derived from aliphatic monoamine and/or a structure derived from a (poly)oxyalkylenemonoamine compound.

In X of the general formula (II), the “organic group that has 1 to 20 carbon atoms” includes methyl, ethyl, tert-butyl, octyl, dodecyl, phenyl, cumyl, methoxy, and ethoxy.

In the case where n=0, the weight average molecular weight (Mw), as measured by GPC, of the thermosetting resin of the present disclosure is preferably not less than 1000, more preferably not less than 1500, even more preferably not less than 2000, still more preferably not less than 2500, and particularly preferably not less than 3000, from the viewpoint of improving the mechanical properties before and after curing. In the case where n=0, the Mw may be not less than 4000 or not less than 5000. In the case where n=1 or more, the Mw is preferably not less than 10000. From the viewpoint of improving the mechanical properties before and after curing, the Mw is more preferably not less than 15000. In the case where n=0, the Mw is preferably less than 10000, more preferably not more than 8000, even more preferably not more than 7000, still more preferably not more than 6000, and still more preferably not more than 5000, from the viewpoint of availability and processability. In the case where n=1 or more, the weight average molecular weight (Mw) is preferably not more than 100000.

### [2. Method for Producing Thermosetting Resin]

A method for producing the thermosetting resin of the present disclosure is a method for producing the thermosetting resin which has the benzoxazine ring structure in the main chain, including:
a step (s1) of reacting the bifunctional phenol compound (A), the aliphatic diamine compound (B), and the aldehyde compound (D);
optionally a step (s2) of reacting the bifunctional phenol compound (A), the (poly)oxyalkylenediamine compound (C), and the aldehyde compound (D); and
optionally a step (s3) of reacting the monofunctional phenol compound (E), wherein:
in a case where the method does not include the step (s2), the method includes the step (s3);
in a case where the method includes the step (s2), the aliphatic diamine compound (B) is an aliphatic diamine that has a linear alkylene group having 6 to 12 carbon atoms, and, in a case where the method does not include the step (s2), the aliphatic diamine compound (B) is an aliphatic diamine that has a linear alkylene group having 8 to 12 carbon atoms; and
the (poly)oxyalkylenediamine compound (C) is a (poly)oxyalkylenediamine compound having a (poly)oxyethylene group and/or a (poly)oxypropylene group.

According to such a method for producing the thermosetting resin, it is possible to obtain the thermosetting resin which is excellent in plasticity before curing and/or excellent in decomposition temperature and toughness before and after curing. Moreover, by reacting the monofunctional phenol compound (E) in the step (s3), it is possible to cap a reactive terminus/termini and accordingly prevent gelation. Note that descriptions of matters which have been already described in the section [1. Thermosetting resin] are omitted.

The step (s1) is a step of reacting the bifunctional phenol compound (A), the aliphatic diamine compound (B), and the aldehyde compound (D). By the step (s1), a unit which is indicated by the polymerization degree m shown in the general formula (I) is produced.

The step (s2) is a step of reacting the bifunctional phenol compound (A), the (poly)oxyalkylenediamine compound (C), and the aldehyde compound (D). By the step (s2), a unit which is indicated by the polymerization degree n shown in the general formula (I) is produced.

The steps (s1) and (s2) may be carried out simultaneously. The step (s1) may be carried out first, and the step (s2) may be carried out later. The step (s2) may be carried out first, and the step (s1) may be carried out later. That is, after the reaction in the step (s1) progresses, the materials in the step (s2) may be added to the same system, and then the step (s2) may be carried out. Alternatively, the opposite may be applied. Alternatively, after the steps (s1) and (s2) are carried out in respective different systems, products obtained in the respective steps (s1) and (s2) may be reacted in a single system. In other words, the production method of the present disclosure can include a step of reacting the bifunctional phenol compound (A), the aliphatic diamine compound (B), the (poly)oxyalkylenediamine compound (C), and the aldehyde compound (D). In the production method of the present disclosure, the aliphatic diamine compound (B) and the (poly)oxyalkylenediamine compound (C) may be introduced simultaneously or may be introduced sequentially. In light of the simplicity of operation, the steps (s1) and (s2) are preferably carried out simultaneously. In the case where the production method includes the step (s2), the production method may or may not include the step (s3).

In the production method, the step (s1) of reacting the bifunctional phenol compound (A), the aliphatic diamine compound (B), and the aldehyde compound (D) and the step (s3) of reacting the monofunctional phenol compound (E) may be carried out simultaneously. Alternatively, the step (s1) may be carried out first, and the step (s3) may be carried out later. That is, after the reaction in the step (s1) progresses, the material in the step (s3) may be added to the same system, and then the step (s3) may be carried out. In light of the simplicity of operation, the steps (s1) and (s3) are preferably carried out simultaneously. It can also be said that the production method in accordance with an embodiment of the present invention can include a step of reacting the bifunctional phenol compound (A), the aliphatic diamine compound (B), the aldehyde compound (D), and the monofunctional phenol compound (E).

In a case where the production method includes the steps (s1), (s2), and (s3), the steps (s1), (s2), and (s3) may be carried out simultaneously. Alternatively, the steps (s1) and (s2) may be carried out first simultaneously, and the step (s3) may be carried out later. Alternatively, the step (s1) may be carried out first, and the steps (s2) and (s3) may be carried out later simultaneously. Alternatively, the step (s2) may be carried out first, and the steps (s1) and (s3) may be carried out later simultaneously. Alternatively, the step (s1) may be carried out first, the step (s2) may be carried out in-between, and the step (s3) may be carried out later. Alternatively, the step (s2) may be carried out first, the step (s1) may be carried out in-between, and the step (s3) may be carried out later. In other words, the production method of the present disclosure can include a step of reacting the bifunctional phenol compound (A), the aliphatic diamine compound (B), the (poly)oxyalkylenediamine compound (C), the aldehyde compound (D), and the monofunctional phenol compound (E). In the production method of the present disclosure, the aliphatic diamine compound (B), the (poly)oxyalkylenediamine compound (C), and the monofunctional phenol compound (E) may be introduced simultaneously or may be introduced sequentially. In light of the simplicity of operation, the steps (s1), (s2), and (s3) are preferably carried out simultaneously.

It is also known that a benzoxazine polymer is poor in stability in a solution state in which the benzoxazine polymer is dissolved in a solvent (storage stability) and easily gelates. Studies by the inventors of the present disclosure clarified that, in a method as disclosed in Patent Literature 1, although it is possible to cap a reactive terminus/termini and accordingly prevent gelation by adding a monofunctional phenol compound, a polymerization reaction in which a molecular weight increases is inhibited and, therefore, it is difficult to obtain benzoxazine which has a high molecular weight.

In the production method of the present disclosure, a ratio between the number of moles of the bifunctional phenol (A) and the total number of moles of the aliphatic diamine compound (B) and the (poly)oxyalkylenediamine compound (C) is preferably the bifunctional phenol (A)/(the aliphatic diamine compound (B)+the (poly)oxyalkylenediamine compound (C))=10/1 to 1/10 and more preferably 2/1 to 1/2. In a case where the ratio between the number of moles of the bifunctional phenol (A) and the total number of moles of the aliphatic diamine compound (B) and the (poly)oxyalkylenediamine compound (C) falls within the above range, it is possible to obtain the thermosetting resin which is unlikely to gelate during production and which has a high molecular weight.

In the production method, in the case where n=0, a ratio between the number of moles of the bifunctional phenol compound (A) and the number of moles of the aliphatic diamine compound (B) is preferably 1.0/1.0 to 1.0/2.0, and more preferably 5.0/10.0 to 7.5/10.0. In a case where the ratio falls within this range, a product which is unlikely to gelate during production and which has a high molecular weight is easily obtained.

In the production method of the present disclosure, a ratio between the number of moles of the (poly)oxyalkylenediamine compound (C) and the number of moles of the aliphatic diamine compound (B) is preferably the (poly)oxyalkylenediamine compound (C)/the aliphatic diamine compound (B)=1/0.1 to 1/100, and more preferably 1/1 to 1/9. In a case where the ratio between the number of moles of the (poly)oxyalkylenediamine compound (C) and the number of moles of the aliphatic diamine compound (B) falls within the above range, it is possible to obtain the thermosetting resin which is excellent in decomposition temperature and toughness before and after curing.

In the production method of the present disclosure, a ratio between the number of moles of the bifunctional phenol compound (A) and the number of moles of the aldehyde compound (D) is preferably 1/1 to 1/20, and more preferably 1/2 to 1/6. In a case where the ratio between the number of moles of the bifunctional phenol compound (A) and the number of moles of the aldehyde compound (D) falls within the above range, it is possible to suitably produce a benzoxazine ring.

In the production method, a ratio between the number of moles of the aliphatic diamine compound (B) and the number of moles of the monofunctional phenol compound (E) is preferably 10.0/1.0 to 10.0/5.0 and/or 10.0/5.0 to 10.0/7.5. In a case where the ratio falls within this range, a product which is unlikely to gelate during production and which has a high molecular weight is easily obtained.

In the production method of the present disclosure, a solvent is not limited in particular, provided that the raw materials can be dissolved therein. Examples of the solvent include halogen-based single solvents such as chloroform; non-halogen-based hydrocarbon solvents such as toluene; mixed solvents of non-halogen-based hydrocarbon solvents and aliphatic alcohol-based solvents such as a mixed solvent of toluene and methanol, a mixed solvent of toluene and ethanol, and a mixed solvent of toluene and isobutanol; and ether-based single solvents such as tetrahydrofuran (THF).

The non-halogen-based hydrocarbon solvents in the mixed solvents are hydrocarbon solvents each of which does not contain a halogen atom and does not contain a heteroatom such as an oxygen atom, a nitrogen atom, and a sulfur atom, and may be aliphatic hydrocarbon, alicyclic hydrocarbon, aromatic hydrocarbon, and the like. Among these solvents, toluene and/or xylene are/is preferable, and toluene is more preferable. The aliphatic alcohol-based solvents are compounds in each of which one or more hydroxyl groups are linked to aliphatic hydrocarbon. Among these solvents, preferable is at least one selected from the group consisting of methanol, ethanol, propanol, and butanol (including structural isomers), and more preferable is at least one selected from the group consisting of methanol, ethanol, and propanol.

A ratio between the volume of a non-halogen-based hydrocarbon solvent and the volume of an aliphatic alcohol-based solvent is preferably (the non-halogen-based hydrocarbon solvent)/(the aliphatic alcohol-based solvent)=50/50 to 80/20.

In the case where n=0, a reaction temperature and a reaction time are also not limited in particular. Typically, the reactions may be carried out at a temperature of room temperature to approximately 120° C. or room temperature to approximately 150° C. for several ten minutes to several hours. In an embodiment of the present invention, the reactions are preferably carried out at a temperature of particularly approximately 30° C. to 110° C. or 30° C. to 150° C. for 20 minutes to 5 hours or 20 minutes to 9 hours, because the reactions progress and result in a polymer which can express a function as the thermosetting resin in accordance with an embodiment of the present invention.

In the case where n=1 or more, the reaction temperature of the step (s1), the step (s2), and/or the step (s3) is preferably 25° C. to 150° C., and more preferably 40° C. to 120° C. In the case where n=1 or more, the reaction time of the step (s1), the step (s2), and/or the step (s3) is preferably 0.5 hours to 10 hours, and more preferably 1 hour to 5 hours.

Removing water generated during the reactions from the system is also an effective method for progressing the reactions. By adding, for example, a large amount of a poor solvent, such as methanol, to a solution after the reactions, it is possible to precipitate the polymer. By separating and drying the polymer, a target polymer is obtained.

In the production method, the obtained product may be washed with use of an aqueous sodium bicarbonate solution or the like. After washing, dehydration may be carried out with use of sodium sulfate or the like.

In the step (s1) and/or the step (s2) of carrying out the reaction(s), the bifunctional phenol compound (A), optionally the diamine compound (B), optionally the (poly)oxyalkylenediamine compound (C), and the aldehyde compound (D) are preferably reacted while being heated in the solvent. In the step (s3) of carrying out the reaction, the monofunctional phenol compound (E) is preferably reacted while being heated in the solvent.

### [3. Composition]

A thermosetting composition which contains the thermosetting resin of the present disclosure as a main component and contains another thermosetting resin, a thermoplastic resin, and a compounding agent as accessory components can be also prepared and used.

Examples of the another thermosetting resin include epoxy-based resins, thermosetting type modified polyphenylene ether resins, thermosetting polyimide resins, silicon resins, melamine resins, uria resins, allyl resins, phenol resins, unsaturated polyester resins, bismaleimide-based resins, alkyd resins, furan resins, polyurethane resins, and aniline resins.

Examples of the thermoplastic resin include thermoplastic epoxy resins and thermoplastic polyimide resins.

The compounding agent includes, as necessary, flame retardants, nucleating agents, antioxidants, anti-aging agents, thermal stabilizers, photo stabilizers, ultraviolet absorbers, lubricants, auxiliary flame retardants, antistatic agents, anti-fogging agents, fillers, softeners, plasticizers, and coloring agents. Each of these agents may be used alone or two or more of these agents may be used in combination. A reactive or non-reactive solvent can also be used.

### [4. Uncured Molded Product (Molded Product of Thermosetting Resin) and Partially Cured Molded Product]

The thermosetting resin or the composition of the thermosetting resin of the present disclosure has moldability also before curing. Therefore, depending on an application and a purpose, it is possible to use an uncured molded product which is obtained by molding the thermosetting resin or the composition without curing or a partially cured molded product which is obtained by curing only a part of the thermosetting resin or the composition without curing completely. A molding temperature in this case (the maximum temperature in a case where the molding temperature is increased gradually) is not limited in particular, but is preferably not lower than room temperature and lower than 200° C., more preferably not lower than 40° C. and not higher than 180° C., still more preferably not lower than 60° C. and not higher than 160° C., and most preferably not lower than 100° C. and not higher than 160° C. In a case where the molding temperature is lower than 200° C., curing does not progress and a desired uncured molded product is obtained.

The dimensions and shape of each of the uncured molded product and the partially cured molded product are not limited in particular. For example, each of the uncured molded product and the partially cured molded product has a film shape, a sheet shape, a plate shape, a block shape, or the like, and may further have another part (e.g., an adhesive layer).

Each of the uncured molded product and the partially cured molded product can be used as a precursor to a cured molded product described later, and can be used, for example, as an adhesive sheet having curability.

The weight reduction rate of each of the uncured molded product and the partially cured molded product is preferably low, from the viewpoint of a decomposition temperature. The weight reduction rate is a rate at which the weight of the thermosetting resin is reduced when the thermosetting resin is heated at a given temperature for a given time, with respect to the weight of the thermosetting resin before heat-curing which weight is regarded as 100. The weight reduction rate may be determined by a thermogravimetric anarysis (TGA). The weight reduction rate is preferably not more than 5%, and more preferably not more than 3%. The weight reduction rate is preferably as low as possible. The lower limit may be, for example, not less than 0.01%. The weight reduction rate may be measured, for example, at a temperature which is premised on thermoplastic working of the uncured molded product or at a temperature which is premised on curing of the uncured molded product. The latter is more preferable.

Each of the uncured molded product and the partially cured molded product preferably has a high decomposition onset temperature. The decomposition onset temperature may be determined from a TG inflection point with use of the above TGA. The decomposition onset temperature is preferably not lower than 250° C., and more preferably not lower than 255° C. This makes it possible to suppress decomposition of a compound when the uncured molded product is cured.

The glass transition temperature (Tg) of the uncured molded product is preferably not higher than 23° C., more preferably not higher than 0° C., and most preferably not higher than −10° C., from the viewpoint of excellent toughness and a high elongation of each of the uncured molded product and the partially cured molded product. From the viewpoint of the decomposition temperature at a time of curing, the glass transition temperature of the uncured molded product is preferably not lower than −150° C., more preferably not lower than −100° C., and preferably not lower than −60° C. In a case where the glass transition temperature falls within the above range, the uncured molded product exhibits excellent toughness and a high elongation even at or around room temperature (25° C.).

The mechanical characteristics of each of the uncured molded product and the partially cured molded product may be evaluated by, for example, a tensile modulus (Modulus), tensile breaking strength, and a tensile elongation at break. Each characteristic may be measured with use of a known tensile tester. It can be said that, as values of the tensile modulus and the tensile breaking strength become lower, each of the uncured molded product and the partially cured molded product is more excellent in plasticity. In contrast, it can be said that, as a value of the tensile elongation at break becomes higher, each of the uncured molded product and the partially cured molded product is more excellent in plasticity.

The tensile modulus of the uncured molded product is preferably not more than 10 GPa, more preferably not more than 5 GPa, and most preferably not more than 1 GPa, from the viewpoint of excellent toughness, a high elongation, and plasticity of the uncured molded product. In particular, in the case where n=1 or more, the tensile modulus of the uncured molded product is preferably not more than 3 GPa, more preferably not more than 1 GPa, and most preferably not more than 0.1 GPa. From the viewpoint of ease of handling of the uncured molded product, the tensile modulus of the uncured molded product is preferably not less than 0.00001 GPa, more preferably not less than 0.0001 GPa, and most preferably not less than 0.001 GPa. In particular, in the case where n=1 or more, the tensile modulus of the uncured molded product is preferably not less than 0.0001 GPa, more preferably not less than 0.005 GPa, and most preferably not less than 0.001 GPa.

From the viewpoint of the plasticity, the tensile breaking strength of the uncured molded product is preferably not more than 500 MPa, more preferably not more than 100 MPa, and most preferably not more than 10 MPa. From the viewpoint of ease of handling and unlikeliness of break of each of the uncured molded product and the partially cured molded product, the tensile breaking strength of the uncured molded product is preferably not less than 0.01 MPa, more preferably not less than 0.1 MPa, and most preferably not less than 1 MPa. In particular, in the case where n=1 or more, the tensile breaking strength of the uncured molded product is preferably not less than 0.1 MPa, more preferably not less than 1 MPa, and most preferably not less than 1.5 MPa.

From the viewpoint of excellent toughness and a high elongation of each of the uncured molded product and the partially cured molded product, the tensile elongation at break of the uncured molded product is preferably not less than 10%, more preferably not less than 50%, and most preferably not less than 100%. In particular, in the case where n=1 or more, the tensile elongation at break of the uncured molded product is preferably not less than 3%, more preferably not less than 10%, and most preferably not less than 80%.

The tensile elongation at break of each of the uncured molded product and the partially cured molded product is preferably not less than 1 time, and preferably not less than 1.5 times the tensile elongation at break of the cured molded product described later. In a case where the tensile elongation at break of the uncured molded product is not less than 1 time the tensile elongation at break of the cured molded product, the uncured molded product has more excellent toughness and a higher elongation than the cured molded product.

Since each of the uncured molded product and the partially cured molded product has excellent toughness, it is possible to deform each of the uncured molded product and the partially cured molded product in any shape. For example, even in a case where an uncured film having excellent toughness is wadded up or deformed in any shape, a break, a crack, or the like does not appear in the uncured film.

Each of the uncured molded product and the partially cured molded product preferably has, at the same time, (i) thermoplastic remoldability and (ii) toughness during remolding. The thermoplastic remoldability means remoldability with which, for example, in a case where each of the uncured molded product and the partially cured molded product is deformed in any shape and then heated at such a temperature that each of the uncured molded product and the partially cured molded product is not cured completely, each of the uncured molded product and the partially cured molded product is restored to a shape before deformation. Such a temperature that each of the uncured molded product and the partially cured molded product is not cured completely is not higher than 200° C. The toughness during remolding refers to a property in which, in a case where each of the uncured molded product and the partially cured molded product is heated at such a temperature that each of the uncured molded product and the partially cured molded product is not cured completely, a break or a crack does not occur before and after the heating. Each of the uncured molded product and the partially cured molded product maintains the remoldability and the toughness even in a case where the deformation and the remolding by the heating are carried out once or more. In this specification, this property is referred to as “repetitive thermoplasticity”. This allows the uncured molded product to be handled easily, and allows the range of use of the uncured molded product to be wider.

The uncured molded product indicates one that has a degree of cure of less than 1%. Note that, for example, the degree of cure of an uncured resin which is not heated at all may be regarded as 0%, and the degree of cure of the cured molded product which is obtained by sufficiently heat-treating the uncured resin and for which, for example, it is confirmed that, in DSC, a peak corresponding to cure has disappeared may be regarded as 100%. The degree of cure of the uncured molded product may be calculated from a ratio between the area of a curing exothermic peak of the uncured resin and the area of a curing exothermic peak of the uncured molded product, each of the curing exothermic peaks being obtained from DSC.

The degree of cure of the partially cured molded product is not less than 1% and not more than 99%. From the viewpoint of the repetitive thermoplasticity, the degree of cure of the partially cured molded product is preferably not less than 1% and less than 90%. In a case where the degree of cure is less than 1%, there is case where, although the thermoplastic remoldability is good, the toughness during remolding is insufficient. In a case where the degree of cure is more than 99%, there is a case where the thermoplastic remoldability is insufficient. In particular, in a case where importance is placed on the thermoplastic remoldability, depending on application of the partially cured molded product or a difference in processing method required, the partially cured molded product which has a lower degree of cure is preferably used. In a case where importance is placed on the toughness during remolding, the partially cured molded product which has a higher degree of cure is preferably used. The degree of cure of the partially cured molded product may be calculated from a ratio between the area of the curing exothermic peak of the uncured resin and the area of a curing exothermic peak of the partially cured molded product, each of the curing exothermic peaks being obtained from DSC.

The degree of cure of the partially cured molded product is more preferably not less than 2% and not more than 80%, more preferably not less than 2% and not more than 70%, more preferably not less than 2% and not more than 60%, even more preferably not less than 3% and not more than 40%, and most preferably not less than 3% and not more than 30%.

Each of the uncured molded product and the partially cured molded product preferably has plasticity. The plasticity may be evaluated, for example, by a mandrel test in conformity with JIS K-5600-5-1:1999. In the mandrel test, it can be evaluated that a material having a smaller bend radius has higher plasticity. In a case where evaluation is carried out by the mandrel test, a bend radius is preferably not more than 2 mm, and more preferably not more than 1 mm. In this case, each of the uncured molded product and the partially cured molded product has such plasticity that each of the uncured molded product and the partially cured molded product can withstand folding at 180 degrees.

### [5. Cured Molded Product (Molded Product of Cured Product)]

In a case where the above-described molded product (uncured molded product) or the partially cured molded product of the thermosetting resin is cured by applying heat thereto, it is possible to obtain the cured molded product. It is also possible to obtain the cured molded product by, without obtaining the uncured molded product or the partially cured molded product, simultaneously molding and heating the thermosetting resin or the composition of the thermosetting resin of the present disclosure so that the thermosetting resin or the composition is cured. A curing temperature in these cases (the maximum temperature in a case where the curing temperature is increased gradually) is not limited in particular, but is preferably not lower than 200° C. and not higher than 300° C., more preferably not lower than 210° C. and not higher than 280° C., even more preferably not lower than 220° C. and not higher than 260° C., and most preferably not lower than 240° C. and not higher than 260° C. In a case where the curing temperature is not lower than 200° C., the molded product which is sufficiently cured is obtained. In a case where the curing temperature is lower than 300° C., thermal decomposition does not progress, and a desired cured molded product is obtained. Note, here, the cured molded product of the present disclosure indicates one that has a degree of cure of more than 99%.

In the case where n=1 or more, the glass transition temperature (Tg) of the cured molded product is preferably not higher than 300° C., more preferably not higher than 250° C., and most preferably not higher than 200° C., from the viewpoint of excellent toughness and a high elongation of the cured molded product. In the case where n=0, the upper limit of Tg is not set. From the viewpoint of a decomposition temperature, the glass transition temperature of the cured molded product is preferably not lower than −150° C., more preferably not lower than −100° C., and even more preferably not lower than −60° C. In a case where the glass transition temperature falls within the above range, the cured molded product exhibits excellent toughness and a high elongation even at or around room temperature (25° C.). In particular, in the case where n=0, the glass transition temperature of the cured molded product is preferably not lower than 100° C., and more preferably not lower than 150° C. In the case where n=0, the glass transition temperature of the cured molded product may be not lower than 200° C. In a case where the glass transition temperature falls within the above range, the cured molded product exhibits excellent heat resistance.

The thermal decomposition temperature (Td5) of the cured molded product means a temperature that is measured in an environment in which the uncured molded product is cured and that is at a time when a compound thermally decomposes and a weight reduces by 5%. The thermal decomposition temperature (Td5) is preferably not lower than 200° C., more preferably not lower than 230° C., and most preferably not lower than 250° C., from the viewpoint of unlikeliness of thermal decomposition of the cured molded product.

From the viewpoint of excellent toughness and a high elongation of the cured molded product, the tensile modulus of the cured molded product is preferably not more than 10 GPa, more preferably not more than 5 GPa, and most preferably not more than 3 GPa. In particular, in the case where n=1 or more, the tensile modulus of the cured molded product is preferably not more than 2 GPa. Moreover, from the viewpoint of ease of handling of the cured molded product, the tensile modulus of the cured molded product is preferably not less than 0.0001 GPa, more preferably not less than 0.0005 GPa, and most preferably not less than 0.001 GPa. In particular, in the case where n=0, the tensile modulus of the cured molded product is preferably not less than 0.1 GPa, more preferably not less than 0.5 GPa, and most preferably not less than 1 GPa.

From the viewpoint of unlikeness of break of the cured molded product, the tensile breaking strength of the cured molded product is preferably not less than 0.1 MPa, more preferably not less than 1 MPa, and most preferably not less than 1.5 MPa. In particular, in the case where n=0, the tensile breaking strength of the cured molded product is preferably not less than 5 MPa, more preferably not less than 10 MPa, and most preferably not less than 50 MPa, from the viewpoint of the toughness.

Moreover, from the viewpoint of ease of handling of the cured molded product, the tensile breaking strength of the cured molded product is preferably not more than 1000 MPa, more preferably not more than 500 MPa, and most preferably not more than 100 MPa.

From the viewpoint of the toughness, the tensile elongation at break of the cured molded product is preferably not less than 0.1%, more preferably not less than 1%, even more preferably not less than 3%, and most preferably not less than 5%. In particular, in the case where n=1 or more, the tensile elongation at break of the cured molded product is preferably not less than 3%, more preferably not less than 4%, and most preferably not less than 5%, from the viewpoint of excellent toughness and a high elongation of the cured molded product.

The cured molded product preferably has plasticity, similarly to the uncured molded product and the partially cured molded product. The plasticity may be evaluated, for example, by a mandrel test in conformity with JIS K-5600-5-1:1999. In a case where evaluation is carried out by the mandrel test, a bend radius is preferably not more than 2 mm. In this case, the cured molded product has such plasticity that the cured molded product can withstand folding at 180 degrees.

The dimensions and shape of the cured molded product are not limited in particular. For example, the cured molded product has a film shape, a sheet shape, a plate shape, a block shape, or the like, and may further have another part (e.g., an adhesive layer).

The cured molded product can be suitably used for electronic components, electronic apparatuses, and materials of the electronic components and the electronic apparatuses. The cured molded product can also be suitably used for multilayer substrates, laminated sheets, sealants, adhesive agents, and the like which are required to have particularly excellent dielectric characteristics. Furthermore, the cured molded product can also be used for aircraft members, automobile members, construction members, and the like. In particular, the cured molded product of the present disclosure can be suitably used to produce semipregs, prepregs, and carbon fiber composite materials.

The cured molded product may contain reinforcement fibers, from the viewpoint of improvement in mechanical strength of the cured molded product. Examples of the reinforcement fibers include inorganic fibers, organic fibers, metal fibers, and hybrid reinforcement fibers which are obtained by combining any of these fibers. One type of reinforcement fibers may be used, or two or more types of reinforcement fibers may be used.

The inorganic fibers include carbon fibers, graphite fibers, silicon carbide fibers, alumina fibers, tungsten carbide fibers, boron fibers, and glass fibers. The organic fibers include aramid fibers, high-density polyethylene fibers, other general nylon fibers, and polyester fibers. The metal fibers include fibers of stainless steel, iron, and the like. The metal fibers also include carbon-coated metal fibers in which metal fibers are coated with carbon. In particular, the reinforcement fibers are preferably carbon fibers, from the viewpoint of an increase in strength of the cured product.

In general, the carbon fibers are subjected to sizing. The carbon fibers may be used as they are. As necessary, the fibers for which a small amount of a sizing agent is used can be used, or the sizing agent can be removed by an existing method such as an organic solvent treatment or a heat treatment. The carbon fibers may be subjected to a process in which a carbon fiber bundle is opened in advance with use of air, a roller, or the like so that the resin is easily impregnated between individual carbon fibers. By reducing the amount of the sizing agent used or by removing the sizing agent, it is possible to suppress formation of a void and discoloration of the resin which are caused by decomposition of the sizing agent at a high temperature.

The embodiments of the present invention also include a prepreg or a semipreg each of which is obtained by impregnating the reinforcement fibers with the thermosetting resin or the composition of the present disclosure. In this specification, the semipreg means a composite obtained by partially impregnating the reinforcement fibers with the thermosetting resin or the composition (semi-impregnated state) so that the reinforcement fibers and the thermosetting resin or the composition are integrated.

The prepreg can be obtained from the semipreg. For example, the prepreg can be obtained by further heating and melting the semipreg and thereby impregnating the reinforcement fibers with the resin. That is, in this specification, the prepreg can be said to be one in which a degree of impregnation of the reinforcement fibers with the resin is higher than in the semipreg.

### [6. Carbon Fiber Composite Material]

The cured molded product of the present disclosure can be used as a carbon fiber composite material. The carbon fiber composite material is also referred to as “carbon fiber reinforced plastic (CFRP)”. A method for preparing the carbon fiber composite material is not limited in particular, and may be, for example, a method in which a semipreg or a prepreg each of which is a sheet obtained by impregnating carbon fibers with the resin is used or a method in which the carbon fibers (in bundled form or fabric form) are impregnated with the resin in liquid form. The cured molded product of present disclosure may be molded into the semipreg or the prepreg, and the semipreg or the prepreg may be used to prepare the carbon fiber composite material.

Note that the carbon fiber composite material is described here as an example, but, as stated above, reinforcement fibers which can be used are not limited to the carbon fibers. That is, the embodiments of the present invention also encompass a fiber composite material which is obtained by impregnating the reinforcement fibers with the thermosetting resin or the composition of the present disclosure and curing the thermosetting resin or the composition.

The semipreg or the prepreg may be obtained, for example, by (i) overlaying the cured molded product of the present disclosure on the top and back of a sheet in which the carbon fibers are impregnated with the resin in advance (carbon fiber plain weave material) and (ii) pressing the cured molded product and the sheet at a given temperature and a given pressure.

Instead of the carbon fibers, the reinforcement fibers described in [5. Cured molded product (molded product of cured product)] may be used for the semipreg or the prepreg.

The carbon fiber composite material may be prepared by stacking a plurality of semipregs or prepregs and pressing the stacked semipregs or prepregs at a given temperature and a given pressure. By such a press, it is possible to suppress a void which is formed mainly between the carbon fibers. Moreover, it is more preferable to carry out the press under a vacuum condition (vacuum press). By the vacuum press, it is also possible to suppress a void which is formed between the resin and the resin. Note that the vacuum press makes it possible to increase a temperature increase rate as compared with a typical press. Alternatively, also by carrying out heating with use of a vacuum oven after the typical press, it is possible to suppress the void which is formed between the resin and the resin.

The pressure is preferably 1 MPa to 5 MPa, and more preferably 1 MPa to 3 MPa. The temperature is preferably not lower than 50° C., and more preferably not lower than 100° C. The temperature is preferably not higher than 400° C., and more preferably not higher than 300° C.

The pressure and the temperature may be increased stepwise. For example, a method for producing the carbon fiber composite material may include (1) a step of carrying out the press under an atmospheric pressure at 50° C. to 200° C. for 5 minutes to 20 minutes, (2) a step of carrying out the press at 1 MPa to 5 MPa and 50° C. to 200° C. for 10 minutes to 30 minutes, and (3) a step of carrying out the press at 1 MPa to 5 MPa and higher than 200° C. and not higher than 400° C. for 1 hour to 5 hours.

Note that, in a case where the temperature is increased during the press, the temperature is preferably increased without taking out the stacked semipregs or prepregs from a pressing machine. This makes it possible to further suppress the void which is formed between the carbon fibers.

The stacked semipregs or the prepregs may be covered with a mold releasing film. Examples of the mold releasing film include polyimide (PI) films. By covering the stacked semipregs or the prepregs in this manner, it is possible to reduce the amount of the resin which bleeds out from the carbon fiber composite material.

### [7. Summary]

The embodiments of the present invention may include the following configurations.

<1> A thermosetting resin which has, in a main chain, a benzoxazine ring structure represented by a general formula (I):

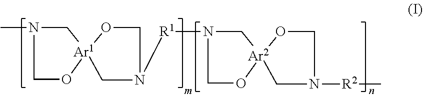

[wherein:
Ar¹ and Ar² each independently represent a tetravalent aromatic group that is derived from a bifunctional phenol compound (A), and may be identical to or different from each other;
n represents an integer of 0 or more;
in a case where n=0, R¹ represents a linear alkylene group that is derived from an aliphatic diamine compound (B) and that has 8 to 12 carbon atoms, and, in a case where n=1 or more, R¹ represents a linear alkylene group that is derived from the aliphatic diamine compound (B) and that has 6 to 12 carbon atoms;
R² represents a (poly)oxyalkylene group that is derived from a (poly)oxyalkylenediamine compound (C);
in the case where n=0, at least one of two termini of the main chain is a group that is derived from a monofunctional phenol compound (E) and that is represented by a general formula (II) below, and the two termini may be identical to or different from each other;
in the case where n=0, m represents an integer of 2 or more, and, in the case where n=1 or more, m represents an integer of 1 or more; and
a repeating unit indicated by m and a repeating unit indicated by n are repeated randomly, repeated as blocks, or copolymerized in an alternating manner],

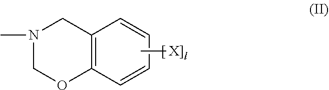

[wherein:
X represents a hydrogen atom or an organic group that has 1 to 20 carbon atoms; and
l represents an integer of 0 to 3].
   <2> The thermosetting resin described in <1>, wherein the bifunctional phenol compound (A) is at least one bifunctional phenol compound selected from the group consisting of 2,2-bis(4-hydroxyphenyl)propane, 1,1-bis(4-hydroxyphenyl)-1-phenylethane, 2,2-bis(4-hydroxyphenyl)hexafluoropropane, 2,2-bis(4-hydroxyphenyl)butane, bis(4-hydroxyphenyl)diphenylmethane, 2,2-bis(3-methyl-4-hydroxyphenyl)propane, bis(4-hydroxyphenyl)-2,2-dichloroethylene, 1,1-bis(4-hydroxyphenyl)ethane, bis(4-hydroxyphenyl)methane, 2,2-bis(4-hydroxy-3-isopropylphenyl)propane, 1,3-bis(2-(4-hydroxyphenyl)-2-propyl)benzene, bis(4-hydroxyphenyl)sulfone, 1,4-bis(2-(4-hydroxyphenyl)-2-propyl)benzene, 5,5′-(1-methylethylidene)-bis[1,1′-(bisphenyl)-2-ol]propane, 1,1-bis(4-hydroxyphenyl)-3,3,5-trimethylcyclohexane, and 1,1-bis(4-hydroxyphenyl)cyclohexane.
   <3> The thermosetting resin described in <1> or <2>, wherein the (poly)oxyalkylenediamine compound (C) has a (poly)oxyethylene group and/or a (poly)oxypropylene group.
   <4> The thermosetting resin described in any one of <1> through <3>, wherein, in the general formula (I), a ratio between m and n is n/m=1/0.1 to 1/100.
   <5> A composition which contains a thermosetting resin described in any one of <1> through <4>.
   <6> An uncured molded product which is obtained by molding a thermosetting resin described in any one of <1> through <4>.
   <7> The uncured molded product described in <6>, wherein a bend radius is not more than 2 mm in a mandrel test in conformity with JIS K-5600-5-1:1999.
   <8> A partially cured molded product which is obtained by partially curing a thermosetting resin described in any one of <1> through <4> and which has a degree of cure of 1% to 99%.
   <9> The partially cured molded product described in <8>, wherein a bend radius is not more than 2 mm in a mandrel test in conformity with JIS K-5600-5-1:1999.
   <10> A cured molded product which is obtained by curing a thermosetting resin described in any one of <1> through <4>.
   <11> The cured molded product described in <10>, wherein a bend radius is not more than 2 mm in a mandrel test in conformity with JIS K-5600-5-1:1999.
   <12> A thermosetting resin which has a benzoxazine ring structure in a main chain, wherein
an uncured molded product that is obtained by molding the thermosetting resin and that has a degree of cure of less than 1% or a partially cured molded product that is obtained by curing the thermosetting resin and that has a degree of cure of 1% to 99% has thermoplastic remoldability and toughness,
the thermoplastic remoldability refers to a property in which, after the uncured molded product or the partially cured molded product is deformed in any shape, the uncured molded product or the partially cured molded product is restored to a shape before deformation, by heating at not higher than 200° C.,
the toughness refers to a property in which a break or a crack does not occur in the uncured molded product or the partially cured molded product before and after the heating, and
the uncured molded product or the partially cured molded product has repetitive thermoplasticity that is a property in which the thermoplastic remoldability and the toughness are maintained even in a case where the deformation and the heating are carried out once or more.
   <13> A method for producing a thermosetting resin which has a benzoxazine ring structure in a main chain, including:
a step (s1) of reacting a bifunctional phenol compound (A), an aliphatic diamine compound (B), and an aldehyde compound (D);
optionally a step (s2) of reacting the bifunctional phenol compound (A), a (poly)oxyalkylenediamine compound (C), and the aldehyde compound (D); and
optionally a step (s3) of reacting a monofunctional phenol compound (E), wherein:
in a case where the method does not include the step (s2), the method includes the step (s3);
in a case where the method includes the step (s2), the aliphatic diamine compound (B) is an aliphatic diamine that has a linear alkylene group having 6 to 12 carbon atoms, and, in a case where the method does not include the step (s2), the aliphatic diamine compound (B) is an aliphatic diamine that has a linear alkylene group having 8 to 12 carbon atoms; and
the (poly)oxyalkylenediamine compound (C) has a (poly)oxyethylene group and/or a (poly)oxypropylene group.
   <14> The method described in <13>, wherein a ratio between the number of moles of the aliphatic diamine compound (B) and the number of moles of the (poly)oxyalkylenediamine compound (C) is the (poly)oxyalkylenediamine compound (C)/the aliphatic diamine compound (B)=1/0.1 to 1/100.

Other embodiments of the present invention may include the following configurations.

<A1> A thermosetting resin which has, in a main chain, a benzoxazine ring structure represented by a general formula (I):

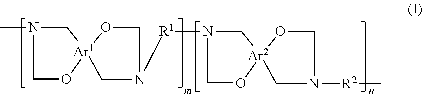

[wherein:
Ar¹ and Ar² each independently represent a tetravalent aromatic group that is derived from a bifunctional phenol compound (A), and may be identical to or different from each other;
R¹ represents a linear alkylene group that is derived from an aliphatic diamine compound (B) and that has 6 to 12 carbon atoms;
R² represents a (poly)oxyalkylene group that is derived from a (poly)oxyalkylenediamine compound (C);
m represents an integer of 1 or more;
n represents an integer of 1 or more; and
a repeating unit indicated by m and a repeating unit indicated by n are repeated randomly, repeated as blocks, or copolymerized in an alternating manner].
   <A2> The thermosetting resin described in <A1>, wherein the bifunctional phenol compound (A) is at least one bifunctional phenol compound selected from the group consisting of 2,2-bis(4-hydroxyphenyl)propane, 1,1-bis(4-hydroxyphenyl)-1-phenylethane, 2,2-bis(4-hydroxyphenyl)hexafluoropropane, 2,2-bis(4-hydroxyphenyl)butane, bis(4-hydroxyphenyl)diphenylmethane, 2,2-bis(3-methyl-4-hydroxyphenyl)propane, bis(4-hydroxyphenyl)-2,2-dichloroethylene, 1,1-bis(4-hydroxyphenyl)ethane, bis(4-hydroxyphenyl)methane, 2,2-bis(4-hydroxy-3-isopropylphenyl)propane, 1,3-bis(2-(4-hydroxyphenyl)-2-propyl)benzene, bis(4-hydroxyphenyl)sulfone, 1,4-bis(2-(4-hydroxyphenyl)-2-propyl)benzene, 5,5′-(1-methylethylidene)-bis[1,1′-(bisphenyl)-2-ol]propane, 1,1-bis(4-hydroxyphenyl)-3,3,5-trimethylcyclohexane, and 1,1-bis(4-hydroxyphenyl)cyclohexane.
   <A3> The thermosetting resin described in <A1> or <A2>, wherein the (poly)oxyalkylenediamine compound (C) has a (poly)oxyethylene group and/or a (poly)oxypropylene group.
   <A4> The thermosetting resin described in any one of <A1> through <A3>, wherein, in the general formula (I), a ratio between m and n is n/m=1/0.1 to 1/100.
   <A5> A composition which contains a thermosetting resin described in any one of <A1> through <A4>.
   <A6> An uncured molded product which is obtained by molding a thermosetting resin described in any one of <A1> through <A4> or a composition described in <A5>.
   <A7> The uncured molded product described in <A6>, wherein a bend radius is not more than 2 mm in a mandrel test in conformity with JIS K-5600-5-1:1999.
   <A8> A partially cured molded product which is obtained by partially curing a thermosetting resin described in any one of <A1> through <A4>, a composition described in <A5>, or an uncured molded product described in <A6> and which has a degree of cure of 1% to 99%.
   <A9> The partially cured molded product described in <A8>, wherein a bend radius is not more than 2 mm in a mandrel test in conformity with JIS K-5600-5-1:1999.
   <A10> A cured molded product which is obtained by curing a thermosetting resin described in any one of <A1> through <A4>, a composition described in <A5>, an uncured molded product described in <A6>, or a partially cured molded product described in <A8>.
   <A11> The cured molded product described in <A10>, wherein a bend radius is not more than 2 mm in a mandrel test in conformity with JIS K-5600-5-1:1999.
   <A12> A thermosetting resin which has a benzoxazine ring structure in a main chain, wherein
an uncured molded product that is obtained by molding the thermosetting resin and that has a degree of cure of less than 1% or a partially cured molded product that is obtained by curing the thermosetting resin and that has a degree of cure of 1% to 99% has thermoplastic remoldability and toughness,
the thermoplastic remoldability refers to a property in which, after the uncured molded product or the partially cured molded product is deformed in any shape, the uncured molded product or the partially cured molded product is restored to a shape before deformation, by heating at not higher than 200° C.,
the toughness refers to a property in which a break or a crack does not occur in the uncured molded product or the partially cured molded product before and after the heating, and
the uncured molded product or the partially cured molded product has repetitive thermoplasticity that is a property in which the thermoplastic remoldability and the toughness are maintained even in a case where the deformation and the heating are carried out once or more.
   <A13> A method for producing a thermosetting resin which has a benzoxazine ring structure in a main chain, including:
a step (s1) of reacting a bifunctional phenol compound (A), an aliphatic diamine compound (B), and an aldehyde compound (D); and
a step (s2) of reacting the bifunctional phenol compound (A), a (poly)oxyalkylenediamine compound (C), and the aldehyde compound (D), wherein
the aliphatic diamine compound (B) is an aliphatic diamine that has a linear alkylene group having 6 to 12 carbon atoms, and
the (poly)oxyalkylenediamine compound (C) has a (poly)oxyethylene group and/or a (poly)oxypropylene group.
   <A14> The method described in <A13>, wherein a ratio between the number of moles of the aliphatic diamine compound (B) and the number of moles of the (poly)oxyalkylenediamine compound (C) is the (poly)oxyalkylenediamine compound (C)/the aliphatic diamine compound (B)=1/0.1 to 1/100.
   <A15> A prepreg or a semipreg each of which is obtained by impregnating reinforcement fibers with a thermosetting resin described in any one of <A1> through <A4> or a composition described in <A5>.
   <A16> A fiber composite material which is obtained by impregnating reinforcement fibers with a thermosetting resin described in any one of <A1> through <A4> or a composition described in <A5> and curing the thermosetting resin or the composition.

Further other embodiments of the present invention may include the following configurations.

<B1> A thermosetting resin which has, in a main chain, a benzoxazine ring structure represented by a general formula (I′):

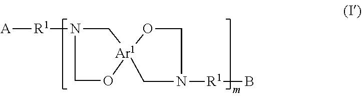

[wherein:
Ar¹ represents a tetravalent aromatic group derived from a bifunctional phenol compound (A);
R¹ represents a linear alkylene group that is derived from an aliphatic diamine compound (B) and that has 8 to 10 carbon atoms;
at least one of A and B is a group that is derived from a monofunctional phenol compound (E) and that is represented by a general formula (II) below, and A and B may be identical to or different from each other; and
m represents an integer of 2 or more],

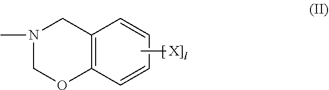

[wherein:
X represents a hydrogen atom or an organic group that has 1 to 20 carbon atoms; and
l represents an integer of 0 to 3].
   <B2> A composition which contains a thermosetting resin described in <B1>.
   <B3> An uncured molded product which is obtained by molding a thermosetting resin described in <B1> or a composition described in <B2>.
   <B4> A cured molded product which is obtained by curing a thermosetting resin described in <B1>, a composition described in <B2>, or an uncured molded product described in <B3>.
   <B5> A method for producing a thermosetting resin which has a benzoxazine ring structure in a main chain, including:
a step (s1) of reacting a bifunctional phenol compound (A), an aliphatic diamine compound (B), and an aldehyde compound (D); and
a step (s3) of further reacting a monofunctional phenol compound (E), wherein:
the aliphatic diamine compound (B) is an aliphatic diamine that has a linear alkylene group having 8 to 10 carbon atoms.

Still other embodiments of the present invention may include the following configurations.

<C1> A thermosetting resin which has, in a main chain, a benzoxazine ring structure represented by a general formula (I′):

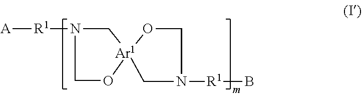

[wherein:
Ar1 represents a tetravalent aromatic group derived from a bifunctional phenol compound (A);
R1 represents a linear alkylene group that is derived from an aliphatic diamine compound (B) and that has 12 carbon atoms;
at least one of A and B is a group that is derived from a monofunctional phenol compound (E) and that is represented by a general formula (II) below, and A and B may be identical to or different from each other; and
m represents an integer of 2 or more],

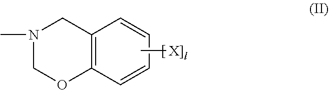

[wherein:
X represents a hydrogen atom or an organic group that has 1 to 20 carbon atoms; and
l represents an integer of 0 to 3].
   <C2> A composition which contains a thermosetting resin described in <C1>.
   <C3> An uncured molded product which is obtained by molding a thermosetting resin described in <C1> or a composition described in <C2>.
   <C4> A cured molded product which is obtained by curing a thermosetting resin described in <C1>, a composition described in <C2>, or an uncured molded product described in <C3>.
   <C5> A method for producing a thermosetting resin which has a benzoxazine ring structure in a main chain, including:
a step (s1) of reacting a bifunctional phenol compound (A), an aliphatic diamine compound (B), and an aldehyde compound (D); and
a step (s3) of further reacting a monofunctional phenol compound (E), wherein:
the aliphatic diamine compound (B) is an aliphatic diamine that has a linear alkylene group having 12 carbon atoms.

The present disclosure is not limited to the embodiments, but can be altered by a skilled person in the art within the scope of the claims. The present disclosure also encompasses, in its technical scope, any embodiment derived by combining technical means disclosed in differing embodiments.

### EXAMPLES

The present invention will be described in detail on the basis of examples. Note, however, that the present invention is not limited to the examples.

### [Test Methods]

The molecular weights, the minimum melt viscosity, the weight reduction rate (%), the decomposition onset temperature (° C.), the glass transition temperature (Tg), the thermal decomposition temperature (Td5), the tensile modulus, the tensile breaking strength, and the tensile elongation at break of a compound obtained in each of the examples and comparative examples below were tested by the following methods.

### (1) Molecular Weight Measurement

The number average molecular weight (Mn) and the weight average molecular weight (Mw) were determined in terms of standard polystyrene with use of a gel permeation chromatography (GPC, manufactured by Shimadzu Corporation).

### (2) Minimum Melt Viscosity Measurement

The minimum melt viscosity was measured with use of ARES G2 (manufactured by TA Instruments) with 25-mm parallel plates, at a temperature increase rate of 5° C./min, at an angular frequency of 10.0 rad/s (1.6 Hz), and with a strain of 0.01%. Note that the minimum melt viscosity means the minimum value of melt viscosity measured under the above condition.

### (3) Weight Reduction Rate (%) and Decomposition Onset Temperature (° C.)

A weight reduction of each of uncured resins was evaluated by thermogravimetry (TGA) with use of a thermogravimetry-differential thermal analyzer (STA7200, manufactured by Hitachi High-Tech Science Corporation) at a temperature increase rate of 5° C./min. The weight reduction rate (%) was determined from a weight at room temperature before start of measurement and the weight after curing. The decomposition onset temperature was determined from a TG inflection point temperature.

### (4) Glass Transition Temperature (Tg)

A DMA curve of each of uncured films and cured films was measured with use of a dynamic viscoelasticity measurement device (DVA-200, manufactured by IT Keisoku Seigyo Kabushikigaisha) at a frequency of 1 Hz and at a temperature increase rate of 5° C./min. A temperature at a point of intersection of (i) a tangent at an inflection point of the obtained DMA curve with respect to a storage elastic modulus (E′) and (ii) a baseline was regarded as Tg.

### (5) Thermal Decomposition Temperature (Td5)

The 5% weight reduction temperature (Td5) of each of the uncured films and the cured films was evaluated by thermogravimetry (TGA) with use of a thermogravimetry-differential thermal analyzer (STA7200, manufactured by Hitachi High-Tech Science Corporation) at a temperature increase rate of 5° C./min. Note that, as the Td5, a numerical value which was obtained by differential thermal analysis (TG-DTA) and which was measured under N₂ gas stream was employed.

### (6) Tensile Modulus (Modulus), Tensile Breaking Strength, and Tensile Elongation at Break

A tensile test was carried out with respect to each of the uncured films (film-shaped uncured products) and the cured films (cured products) with use of a tensile tester (EZ-SX, manufactured by Shimadzu Corporation). A test temperature was set to room temperature. A tensile speed was set to 5 mm/min. The shape of each test piece was 50 mm long and 3 mm wide.

### (7) Thermoplasticity (Toughness During Remolding, Thermoplastic Remoldability)

The thermoplasticity (toughness during remolding and thermoplastic remoldability) of each of the uncured films and partially cured films was visually evaluated. The toughness was evaluated by visually observing the presence or absence of a break, a crack, or the like in each of the films when each of the films was manually deformed each of before and after heating. The remoldability was evaluated by whether or not each of the deformed films was restored to a state before deformation, when each of the deformed films was heated for a given time at such a given temperature that each of the deformed films was not cured completely.

### (Criteria of Evaluation of Toughness)

Good . . . No break or crack was observed in the film.
Poor . . . A break or crack was observed in the film.

### (Criteria of Evaluation of Remoldability)

Good . . . The film was restored to the state before the deformation.
Poor . . . The film was remained deformed or was not restored to the state before the deformation.

### (8) Plasticity Evaluation (Mandrel Test)

The plasticity of each of the partially cured films and the cured films was evaluated by a mandrel test in conformity with JIS K-5600-5-1:1999. The Elcometer 1500 Cylindrical Mandrel set was used. Each of the films was hung on each of a plurality of cylindrical mandrels having different diameters (2 mm to 32 mm), and both ends of each of the films were pulled. That is, both ends of each of the films were pulled perpendicularly with respect to the lengthwise direction of each of the cylindrical mandrels in a state where each of the films was bent along the circumferential surface of each of the cylindrical mandrels. In this case, the diameter of a smallest one of the cylindrical mandrels with which a break did not occur was determined and regarded as a bend radius (mm).

### <Production of Resin>

Materials used to produce resins are shown below.

### (Bifunctional Phenol Compound (A))

2,2-bis(4-hydroxyphenyl)propane (bisphenol A, BisA) (manufactured by Tokyo Chemical Industry Co., Ltd. (TCI))

### (Aliphatic Diamine Compound (B))

Hexamethylenediamine (HMD) (manufactured by Tokyo Chemical Industry Co., Ltd. (TCI))
Octamethylenediamine (manufactured by Tokyo Chemical Industry Co., Ltd. (TCI))
Decamethylenediamine (manufactured by Tokyo Chemical Industry Co., Ltd. (TCI))
Dodecamethylenediamine (manufactured by Tokyo Chemical Industry Co., Ltd. (TCI))

### ((Poly)Oxyalkylenediamine Compound (C)))

Jeffamine D2000 (manufactured by Hentsman)

### (Aldehyde Compound (D))

Paraformaldehyde (manufactured by Merck)

### (Monofunctional Phenol Compound (E))

Phenol (manufactured by Tokyo Chemical Industry Co., Ltd. (TCI))

### Example 1 (C8Bz)

A benzoxazine-based thermosetting resin (C8Bz) which had a structural unit derived from C8 diamine (octamethylenediamine) was obtained by the following method.

Into chloroform (30 mL), 3.1961 g (0.014 mol) of bisphenol A, 3.1654 g (0.020 mol) of octamethylenediamine, 2.5832 g (0.086 mol) of paraformaldehyde, and 1.1316 g (0.012 mol) of phenol were introduced and reacted at 60° C. After elapse of 4 hours, the reaction was stopped. After a reaction solution was cooled to room temperature, a separation process was carried out 3 times with use of 60 mL of a 0.1 N sodium hydrogen carbonate solution. The reaction solution which had been washed with sodium sulfate was dehydrated and filtered. A solvent was removed by heating under reduced pressure in an evaporator. Then, drying was carried out at 40° C. under reduced pressure in a vacuum oven. In this manner, a powdery benzoxazine resin which was a target compound was obtained. According to measurement of molecular weights by GPC, the number average molecular weight (Mn) was 1552 and the weight-average molecular weight (Mw) was 4404, in terms of standard polystyrene.

The obtained powdery benzoxazine resin was heated at 100° C. for 30 minutes with use of a hot press, and thereby a film-shaped uncured product was obtained. Furthermore, the powdery benzoxazine resin was heated at 200° C. for 1 hour, at 240° C. for 1 hour, and then at 260° C. for 30 minutes in an oven so as to be cured, and thereby a film-shaped cured product was obtained. Table 1 shows the characteristics of the film-shaped uncured product and the film-shaped cured product.

### Example 2 (C10Bz)

A benzoxazine-based thermosetting resin (C10Bz) which had a structural unit derived from C10 diamine (decamethylenediamine) was obtained by the following method.

Into chloroform (40 mL), 6.3920 g (0.028 mol) of bisphenol A, 6.9328 g (0.040 mol) of decamethylenediamine, 5.1654 g (0.172 mol) of paraformaldehyde, and 2.2586 g (0.024 mol) of phenol were introduced and reacted at 60° C. After elapse of 4 hours, the reaction was stopped. After a reaction solution was cooled to room temperature, a separation process was carried out 3 times with use of 80 mL of a 0.1 N sodium hydrogen carbonate solution. The reaction solution which had been washed with sodium sulfate was dehydrated and filtered. A solvent was removed by heating under reduced pressure in an evaporator. Then, drying was carried out at 40° C. under reduced pressure in a vacuum oven. In this manner, a powdery benzoxazine resin which was a target compound was obtained. According to measurement of molecular weights by GPC, the number average molecular weight (Mn) was 2097 and the weight-average molecular weight (Mw) was 4582, in terms of standard polystyrene.

The obtained powdery benzoxazine resin was heated at 100° C. for 30 minutes with use of a hot press, and thereby a film-shaped uncured product was obtained. Furthermore, the powdery benzoxazine resin was heated at 200° C. for 1 hour, at 240° C. for 1 hour, and then at 260° C. for 30 minutes in an oven so as to be cured, and thereby a film-shaped cured product was obtained. Table 1 shows the characteristics of the film-shaped uncured product and the film-shaped cured product.

### Example 3 (C12Bz)

A benzoxazine-based thermosetting resin (C12Bz) which had a structural unit derived from C12 diamine (dodecamethylenediamine) was obtained by the following method.

Into a mixed solvent of toluene (57.96 mL) and isobutanol (10.23 mL), 6.2324 g (0.027 mol) of bisphenol A, 6.0012 g (0.030 mol) of dodecamethylenediamine, 5.4051 g (0.180 mol) of paraformaldehyde, and 0.7678 g (0.008 mol) of phenol were introduced and reacted at 100° C. After elapse of 4 hours, the reaction was stopped. After a reaction solution was cooled to room temperature, a separation process was carried out 4 times with use of 500 mL of a 0.03 N aqueous sodium hydroxide solution. The reaction solution which had been washed with sodium sulfate was dehydrated and filtered. A solvent was removed by heating under reduced pressure in an evaporator. Then, drying was carried out at 60° C. under reduced pressure in a vacuum oven. In this manner, a powdery benzoxazine resin which was a target compound was obtained. According to measurement of molecular weights by GPC, the number average molecular weight (Mn) was 2831 and the weight-average molecular weight (Mw) was 5509, in terms of standard polystyrene.

The obtained powdery benzoxazine resin was heated at 100° C. for 30 minutes with use of a hot press, and thereby a film-shaped uncured product was obtained. Furthermore, the powdery benzoxazine resin was heated at 200° C. for 1 hour, at 240° C. for 1 hour, and then at 260° C. for 30 minutes in an oven so as to be cured, and thereby a film-shaped cured product was obtained. Table 1 shows the characteristics of the film-shaped uncured product and the film-shaped cured product.

### Example 4 (JD11)

Into chloroform (40 mL), bisphenol A (4.5669 g, 0.02 mol), hexamethylenediamine (1.1631 g, 0.01 mol), Jeffamine D2000 (20.0191 g, 0.01 mol), and paraformaldehyde (2.5868 g, 0.086 mol) were introduced and reacted at 60° C. After elapse of 5 hours, the reaction was stopped. After a reaction solution was cooled to room temperature, a separation process was carried out 3 times with use of 60 mL of a 0.1 N sodium hydrogen carbonate solution. The reaction solution which had been washed with sodium sulfate was dehydrated and filtered. A solvent was removed by heating under reduced pressure in an evaporator. Then, drying was carried out at 40° C. under reduced pressure in a vacuum oven. In this manner, a powdery benzoxazine resin which was a target compound was obtained. According to measurement of molecular weights by GPC, the number average molecular weight (Mn) was 6061 and the weight-average molecular weight (Mw) was 17568, in terms of standard polystyrene.

The obtained powdery benzoxazine resin was heated and pressurized at 160° C. and 10 MPa for 30 minutes with use of a hot press, and thereby a film-shaped uncured molded product (uncured film) was obtained. The obtained uncured film was heated at 210° C. for 2 hours in a convection oven so as to be cured, and thereby a film-shaped cured molded product (cured film) was obtained. Table 1 shows the characteristics of the uncured film and the cured film. Note that, since a molar ratio between Jeffamine D2000 and the hexamethylenediamine used is 1:1, the benzoxazine resin obtained in Example 4 is also referred to as JD11.

### Example 5 (JD13)

Into chloroform (40 mL), bisphenol A (4.5665 g, 0.02 mol), hexamethylenediamine (1.7444 g, 0.015 mol), Jeffamine D2000 (10.0161 g, 0.005 mol), and paraformaldehyde (2.5857 g, 0.086 mol) were introduced and reacted at 60° C. After elapse of 5 hours, the reaction was stopped. After a reaction solution was cooled to room temperature, a separation process was carried out 3 times with use of 60 mL of a 0.1 N sodium hydrogen carbonate solution. The reaction solution which had been washed with sodium sulfate was dehydrated and filtered. A solvent was removed by heating under reduced pressure in an evaporator. Then, drying was carried out at 40° C. under reduced pressure in a vacuum oven. In this manner, a powdery benzoxazine resin which was a target compound was obtained. According to measurement of molecular weights by GPC, the number average molecular weight (Mn) was 5939 and the weight-average molecular weight (Mw) was 17377, in terms of standard polystyrene.

The obtained powdery benzoxazine resin was heated and pressurized at 100° C. or 140° C. and 10 MPa for 30 minutes with use of a hot press, and thereby an uncured film was obtained. The obtained uncured film was heated at 210° C. for 3 hours in a convection oven so as to be cured, and thereby a cured film was obtained. Table 1 shows the characteristics of the uncured film and the cured film. Note that, since a molar ratio between Jeffamine D2000 and the hexamethylenediamine used is 1:3, the benzoxazine resin obtained in Example 5 is also referred to as JD13.

### Example 6 (JD19)

Into chloroform (40 mL), bisphenol A (4.5666 g, 0.02 mol), hexamethylenediamine (2.0923 g, 0.018 mol), Jeffamine D2000 (4.0000 g, 0.002 mol), and paraformaldehyde (2.5840 g, 0.086 mol) were introduced and reacted at 60° C. After elapse of 5 hours, the reaction was stopped. After a reaction solution was cooled to room temperature, a separation process was carried out 3 times with use of 60 mL of a 0.1 N sodium hydrogen carbonate solution. The reaction solution which had been washed with sodium sulfate was dehydrated and filtered. A solvent was removed by heating under reduced pressure in an evaporator. Then, drying was carried out at 40° C. under reduced pressure in a vacuum oven. In this manner, a powdery benzoxazine resin which was a target compound was obtained. According to measurement of molecular weights by GPC, the number average molecular weight (Mn) was 6063 and the weight-average molecular weight (Mw) was 17414, in terms of standard polystyrene.

The obtained powdery benzoxazine resin was heated and pressurized at 100° C. and 10 MPa for 30 minutes with use of a hot press, and thereby an uncured film was obtained. The obtained uncured film was heated at 220° C. for 2 hours in a convection oven so as to be cured, and thereby a cured film was obtained. Table 1 shows the characteristics of the uncured film and the cured film. Note that, since a molar ratio between Jeffamine D2000 and the hexamethylenediamine used is 1:9, the benzoxazine resin obtained in Example 6 is also referred to as JD19.

### Comparative Example 1 (C6Bz1)

Into a mixed solvent of toluene (38.6 mL) and isobutanol (6.8 mL), 4.1505 g (0.018 mol) of bisphenol A, 2.3243 g (0.020 mol) of hexamethylenediamine, 3.6053 g (0.120 mol) of paraformaldehyde, and 0.5149 g (0.005 mol) of phenol were introduced and reacted at 90° C. After elapse of 5 hours, the reaction was stopped. A reaction solution was introduced into 800 mL of methanol, and a target compound was precipitated. Thereafter, the target compound was separated by filtration, and dried at 45° C. under reduced pressure in a vacuum oven. In this manner, the target compound was obtained. According to measurement of molecular weights by GPC, the number average molecular weight (Mn) was 2733 and the weight-average molecular weight (Mw) was 7146, in terms of standard polystyrene.

The obtained powdery benzoxazine resin was heated at 120° C. for 40 minutes, heated to 160° C., and then heated and pressurized at 10 MPa for 30 minutes with use of a hot press. An uncured film was thereby obtained. Furthermore, the powdery benzoxazine resin was heated at 200° C. for 1 hour, at 240° C. for 1 hour, and then at 260° C. for 30 minutes in an oven so as to be cured, and thereby a film-shaped cured product was obtained. Table 1 shows the characteristics of the film-shaped uncured product and the film-shaped cured product.

### Comparative Example 2 (C6Bz2)

Into chloroform (150 mL), 9.5889 g (0.042 mol) of bisphenol A, 6.9718 g (0.060 mol) of hexamethylenediamine, 7.7485 g (0.258 mol) of paraformaldehyde, and 3.3887 g (0.036 mol) of phenol were introduced and reacted at 60° C. After elapse of 5 hours, the reaction was stopped. After a reaction solution was cooled to room temperature, a separation process was carried out 3 times with use of 300 mL of a 0.1 N sodium hydrogen carbonate solution. The reaction solution which had been washed with sodium sulfate was dehydrated and filtered. A solvent was removed by heating under reduced pressure in an evaporator. Then, drying was carried out at 40° C. under reduced pressure in a vacuum oven. In this manner, a target compound was obtained. According to measurement of molecular weights by GPC, the number average molecular weight (Mn) was 1884 and the weight-average molecular weight (Mw) was 3847, in terms of standard polystyrene.

This powdery benzoxazine was heated at 120° C. for 40 minutes, heated to 160° C., and then heated and pressurized at 10 MPa for 30 minutes with use of a hot press. An uncured film was thereby obtained. Furthermore, the powdery benzoxazine was heated at 200° C. for 1 hour, at 240° C. for 1 hour, and then at 260° C. for 30 minutes in an oven so as to be cured, and thereby a film-shaped cured product was obtained. Table 1 shows the characteristics of the film-shaped uncured product and the film-shaped cured product.

TABLE 1

| | | | | Example 1 | | Example 2 | | Example 3 | |
|---|---|---|---|---|---|---|---|---|---|
| | | | | C8Bz | | C10Bz | | C12Bz | |
| Number of | Phenol | Bifunctional phenol | BisA | 0.014 | mol | 0.028 | mol | 0.027 | mol |
| moles of | compound | compound (A) | | | | | | | |
| each raw | | Monofunctional phenol | Phenol | 0.012 | mol | 0.024 | mol | 0.008 | mol |
| material | | compound (E) | | | | | | | |

| | | | | | | |
|---|---|---|---|---|---|---|
| compound | Amine | Aliphatic diamine | Hexamethy- | — | — | — |
| (mol) | compound | compound (B) | lenediamine | | | |

| | | | | |
|---|---|---|---|---|
| Octamethy- | 0.020 | mol | — | — |
| lenediamine | | | | |

| | | | | |
|---|---|---|---|---|
| Decamethy- | — | 0.040 | mol | — |
| lenediamine | | | | |

| | | | | |
|---|---|---|---|---|
| Dodecamethy- | — | — | 0.030 | mol |
| lenediamine | | | | |

| | | | | |
|---|---|---|---|---|
| (Poly)oxyalkylene | Jeffamine | — | — | — |
| diamine compound (C) | D2000 | | | |

| | | | | | | | |
|---|---|---|---|---|---|---|---|
| Aldehyde compound (D) | Paraformal- | 0.086 | mol | 0.172 | mol | 0.180 | mol |
| | dehyde (HCHO) | | | | | | |

| Molar ratio | (Poly)oxyalkylenediamine compound | | — | — | — |
|---|---|---|---|---|---|
| between | (C)/Aliphatic diamine compound (B) | | | | |
| raw material | Amine compound/HCHO/Phenol compound | | 1.0/4.3/1.3 | 1.0/4.3/1.3 | 1.0/6.0/1.2 |
| compounds | | | | | |
| Reaction | Solvent | | CHCl₃ | CHCl₃ | Toluene/iBuOH |
| conditions | Reaction temperature (° C.), time (h) | | 60° C., 4 h | 60° C., 4 h | 100° C., 4 h |
| Before | Number average molecular weight (Mn)/Weight | | 1552/4404 | 2097/4582 | 2831/5509 |
| curing | average molecular weight (Mw) | | | | |
| | Minimum melt viscosity (Pa*s) (temperature (° C.)) | | — | — | — |
| | Uncured/partially cured film molding | | 100° C., 30 min | 100° C., 30 min | 100° C., 30 min |
| | temperature, molding time | | | | |
| | Uncured/ | Weight reduction rate by TGA | — | — | — |
| | partially | Decomposition onset temperature (° C.) | — | — | — |
| | cured film | Glass transition temperature Tg (° C.) DMA | 2.2 | −3.2 | −2.4 |
| | | Thermal decomposition temperature Td5 (° C.) | — | — | — |
| | | Tensile modulus (Modulus) (GPa) | 0.2 | 0.007 | 0.002 |
| | | Tensile breaking strength (MPa) | 3.5 | 2.4 | 1.6 |
| | | Tensile elongation at break (%) | 220 | 333 | 281 |
| After | Curing temperature, curing time of cured film | | 200° C., 1 h→ | 200° C., 1 h→ | 200° C., 1 h→ |
| curing | | | 240° C., 1 h→ | 240° C., 1 h→ | 240° C., 1 h→ |
| | | | 260° C., 30 min | 260° C., 30 min | 260° C., 30 min |
| | Cured film | Tg (° C.) | 232 | 226 | 212 |
| | | Td5 (° C.) | 319 | 333 | 331 |
| | | Tensile modulus (Modulus) (GPa) | 2.3 | 1.4 | 1.8 |
| | | Tensile breaking strength (MPa) | 78 | 69 | 68 |
| | | Tensile elongation at break (%) | 4.4 | 7.8 | 5.9 |

| | | | | Example 4 | | Example 5 | | Example 6 | |
|---|---|---|---|---|---|---|---|---|---|
| | | | | JD11 | | JD13 | | JD19 | |
| Number of | Phenol | Bifunctional phenol | BisA | 0.02 | mol | 0.02 | mol | 0.02 | mol |
| moles of | compound | compound (A) | | | | | | | |
| each raw | | Monofunctional phenol | Phenol | — | | — | | — | |
| material | | compound (E) | | | | | | | |
| compound | Amine | Aliphatic diamine | Hexamethy- | 0.01 | mol | 0.015 | mol | 0.018 | mol |
| (mol) | compound | compound (B) | lenediamine | | | | | | |

| | Octamethy- | — | | — | | — | |
|---|---|---|---|---|---|---|---|
| | lenediamine | | | | | | |
| | Decamethy- | — | | — | | — | |
| | lenediamine | | | | | | |
| | Dodecamethy- | — | | — | | — | |
| | lenediamine | | | | | | |
| (Poly)oxyalkylene | Jeffamine | 0.01 | mol | 0.005 | mol | 0.002 | mol |
| diamine compound (C) | D2000 | | | | | | |

| | | | | | | | |
|---|---|---|---|---|---|---|---|
| Aldehyde compound (D) | Paraformal- | 0.086 | mol | 0.086 | mol | 0.086 | mol |
| | dehyde (HCHO) | | | | | | |

| Molar ratio | (Poly)oxyalkylenediamine compound | | 1/1 | 1/3 | 1/9 |
|---|---|---|---|---|---|
| between | (C)/Aliphatic diamine compound (B) | | | | |
| raw material | Amine compound/HCHO/Phenol compound | | 1.0/4.3/1.0 | 1.0/4.3/1.0 | 1.0/4.3/1.0 |
| compounds | | | | | |
| Reaction | Solvent | | CHCl₃ | CHCl₃ | CHCl₃ |
| conditions | Reaction temperature (° C.), time (h) | | 60° C., 5 h | 60° C., 5 h | 60° C., 5 h |
| Before | Number average molecular weight (Mn)/Weight | | 6061/17568 | 5939/17377 | 6063/17414 |
| curing | average molecular weight (Mw) | | | | |
| | Minimum melt viscosity (Pa*s) (temperature (° C.)) | | 0.7 (103) | 197(92) | 134(99) |
| | Uncured/partially cured film molding | | 160° C., 30 min | 140° C., 30 min | 100° C., 30 min |
| | temperature, molding time | | | (100° C., 30 min *1) | |
| | Uncured/ | Weight reduction rate by TGA | 1.0% | 3.0% | 2.0% |
| | partially | | (210° C., 2 h) | (210° C., 3 h) | (220° C., 2 h) |
| | cured film | Decomposition onset temperature (° C.) | 258.7 | 256.9 | 258.9 |
| | | Glass transition temperature Tg (° C.) DMA | −51 | −46 | −10 |
| | | Thermal decomposition temperature Td5 (° C.) | 290 | 291 | 286 |

| | | | | |
|---|---|---|---|---|
| Tensile modulus (Modulus) (GPa) | 0.002 | 0.004 | (0.001 *1) | 0.072 |
| Tensile breaking strength (MPa) | 1.5 | 5.2 | (0.4 *1) | 21 |
| Tensile elongation at break (%) | 87 | 162 | (352 *1) | 386 |

| After | Curing temperature, curing time of cured film | | 210° C., 2 h | 210° C., 3 h | 220° C., 2 h |
|---|---|---|---|---|---|
| curing | Cured film | Tg (° C.) | −55 | −56, 102 | 197 |
| | | Td5 (° C.) | 282 | 304 | 295 |
| | | Tensile modulus (Modulus) (GPa) | 0.004 | 0.2 | 1.2 |
| | | Tensile breaking strength (MPa) | 1.8 | 9.6 | 41 |
| | | Tensile elongation at break (%) | 52 | 21 | 7.3 |

| | | | | Comparative | | Comparative | |
|---|---|---|---|---|---|---|---|
| | | | | Example 1 | | Example 2 | |
| | | | | C6Bz1 | | C6Bz2 | |
| Number of | Phenol | Bifunctional phenol | BisA | 0.018 | mol | 0.042 | mol |
| moles of | compound | compound (A) | | | | | |
| each raw | | Monofunctional phenol | Phenol | 0.005 | mol | 0.036 | mol |
| material | | compound (E) | | | | | |
| compound | Amine | Aliphatic diamine | Hexamethy- | 0.02 | mol | 0.06 | mol |
| (mol) | compound | compound (B) | lenediamine | | | | |

| | | | |
|---|---|---|---|
| | Octamethy- | — | — |
| | lenediamine | | |
| | Decamethy- | — | — |
| | lenediamine | | |
| | Dodecamethy- | — | — |
| | lenediamine | | |
| (Poly)oxyalkylene | Jeffamine | — | — |
| diamine compound (C) | D2000 | | |

| | | | | | |
|---|---|---|---|---|---|
| Aldehyde compound (D) | Paraformal- | 0.12 | mol | 0.258 | mol |
| | dehyde (HCHO) | | | | |

| Molar ratio | (Poly)oxyalkylenediamine compound | | — | — |
|---|---|---|---|---|
| between | (C)/Aliphatic diamine compound (B) | | | |
| raw material | Amine compound/HCHO/Phenol compound | | 1.0/6.0/1.2 | 1.0/4.3/1.3 |
| compounds | | | | |
| Reaction | Solvent | | Toluene/iBuOH | CHCl₃ |
| conditions | Reaction temperature (° C.), time (h) | | 90° C., 5 h | 60° C., 5 h |
| Before | Number average molecular weight (Mn)/Weight | | 2733/7146 | 1884/3847 |
| curing | average molecular weight (Mw) | | | |
| | Minimum melt viscosity (Pa*s) (temperature (° C.)) | | — | 43(120) |
| | Uncured/partially cured film molding | | 120° C., 40 min→ | 120° C., 40 min→ |
| | temperature, molding time | | 160° C., 30 min | 160° C., 30 min |
| | Uncured/ | Weight reduction rate by TGA | — | 9.0% |
| | partially | | | (240° C., 1 h→ |
| | cured film | | | 260° C., 30 min) |
| | | Decomposition onset temperature (° C.) | — | 248.5 |
| | | Glass transition temperature Tg (° C.) DMA | 50 | 63 |
| | | Thermal decomposition temperature Td5 (° C.) | — | 266 |
| | | Tensile modulus (Modulus) (GPa) | 2.2 | 2.1 |
| | | Tensile breaking strength (MPa) | 62 | 60 |
| | | Tensile elongation at break (%) | 4.3 | 3.9 |
| After | Curing temperature, curing time of cured film | | 200° C., 1 h→ | 200° C., 1 h→ |
| curing | | | 240° C., 1 h→ | 240° C., 1 h→ |
| | | | 260° C., 30 min | 260° C., 30 min |
| | Cured film | Tg (° C.) | 222 | 234 |
| | | Td5 (° C.) | — | 334 |
| | | Tensile modulus (Modulus) (GPa) | 2.6 | 2.6 |
| | | Tensile breaking strength (MPa) | 81 | 68 |
| | | Tensile elongation at break (%) | 4.6 | 3.5 |

*1 Measured on uncured powder

With regard to before curing, it was found that, in each of Examples 1 through 6, in each of which the diamine compound in accordance with an embodiment of the present invention was used, thermoplastic molding before curing was possible because the film-shaped molded product was obtained by hot press. Moreover, with regard to the thermophysical properties and the mechanical properties of the obtained uncured molded product, it was found from Table 1 that the Tg, the tensile modulus, and the tensile breaking strength were lower and the tensile elongation at break was higher in each of Examples 1 to 6 than in each of Comparative Examples 1 and 2. Therefore, with regard to before curing, it was clarified that more excellent plasticity was exhibited in each of Examples 1 to 6 than in each of Comparative Examples 1 and 2.

With regard to after curing, the Tg in each of Examples 1 to 3 was comparable to that in each of Comparison Examples 1 and 2, and excellent heat resistance was exhibited in each of Examples 1 to 3, despite elongation of an alkyl chain. Moreover, it was found that the tensile modulus, the tensile breaking strength, and the tensile elongation at break in Example 1 were comparable to those in each of Comparison Examples 1 and 2 and excellent hardness was exhibited in Example 1. On the other hand, it was found that, since the tensile modulus and the tensile breaking strength were lower and the tensile elongation at break was higher in each of Examples 2 and 3 than in each of Comparison Examples 1 and 2, excellent toughness was exhibited in each of Examples 2 and 3.

JD11 in Example 4 was cured completely at 210° C. and in 2 hours, and the weight reduction rate was 1.0%. JD13 in Example 5 was cured completely at 210° C. and in 3 hours, and the weight reduction rate was 3.0%. JD19 in Example 6 was cured completely at 220° C. and in 2 hours, and the weight reduction rate was 2.0%. In contrast, C6Bz2 in Comparative Example 2 required heating at 240° C. for 1 hour and then at 260° C. for 30 minutes before the resin was cured completely, and the weight reduction rate was 9.0%. From these results, it was found that the weight reduction rate of the thermosetting resin, i.e., a rate of decomposition, was reduced by using Jeffamine D2000, which was the (poly)oxyalkylenediamine compound (C), and hexamethylenediamine, which was the aliphatic diamine compound (B).

The decomposition onset temperature of the uncured film or the partially cured film in each of Examples 4 to 6 was 8 to 10° C. higher than the decomposition onset temperature of the uncured film in Comparative Example 2. From this result, it was found that the decomposition onset temperature was increased by using Jeffamine D2000, which was the (poly)oxyalkylenediamine compound (C), and hexamethylenediamine, which was the aliphatic diamine compound (B).

The tensile elongation at break of the uncured film, the partially cured film, and the cured film in each of Examples 4 to 6 was significantly higher than the tensile elongation at break in each of Comparative Examples 1 and 2. From this result, it was found that the toughness before and after curing was increased by using Jeffamine D2000, which was the (poly)oxyalkylenediamine compound (C), and hexamethylenediamine, which was the aliphatic diamine compound (B).

Comparative Examples 1 and 2 differ from each other in solvent used to produce the thermosetting resin. In Comparative Example 1, a mixed solvent of a non-halogen-based hydrocarbon solvent and an aliphatic alcohol-based solvent was used. In Comparative Example 2, a halogen-based solvent was used alone. According to Table 1, when the mechanical characteristics in Comparative Example 1 and the mechanical characteristics in Comparative Example 2 are compared, no major difference was observed both before and after curing. Therefore, it was indicated that the difference in solvent was unlikely to affect the mechanical characteristics before and after curing.

### <Evaluation of Remoldability>

### Example 7

On a mold release PET (thickness of 50 μm), a mold release PET spacer which had a hole (thickness of 50 μm, 10-cm square) in the central part thereof was placed. The resin prepared in Example 4 was placed in the hole, and overlaid with a mold release PET. A laminate thus obtained was sandwiched between stainless steel sheets. With use of a press molding machine, the laminate was heated at 160° C. for 5 minutes, and then press-molded at a pressure of 10 MPa for 5 minutes. In this manner, a film having a thickness of 0.05 mm was obtained. The obtained film was fixed in a frame, and the ends of the film were removed by cutting the ends along the outside edges of the frame with use of a cutter. As a result, an independent and flexible film was obtained. Thereafter, the film was manually crushed and wadded up. However, no break was observed in the film. The film was placed in the frame again, overlaid with a mold release PET, and then sandwiched between stainless steel sheets. With use of a press molding machine, a laminate of the film and the mold release PET was heated at 160° C. for 5 minutes, and then press-molded at a pressure of 10 MPa for 5 minutes. As a result, the film having a thickness of 0.05 mm was restored completely.

Thus, it is found that, since a break, a crack, or the like does not appear in the uncured or partially cured film obtained from the resin prepared in Example 4 even in a case where the uncured or partially cured film is wadded up or deformed in any shape, the uncured or partially cured film has excellent toughness. Moreover, it is found that the uncured film or the partially cured film in this example has, at the same time, (i) thermoplastic remoldability and (ii) toughness during remolding.

### Example 8

On a mold release PET (thickness of 50 μm), a mold release PET spacer which had a hole (thickness of 50 μm, 10-cm square) in the central part thereof was placed. The resin prepared in Example 5 was placed in the hole, and overlaid with a mold release PET. A laminate thus obtained was sandwiched between stainless steel sheets. With use of a press molding machine, the laminate was heated at 140° C. for 5 minutes, and then press-molded at a pressure of 10 MPa for 5 minutes. As a result, a film having a thickness of 0.05 mm was obtained. The obtained film was fixed in a frame, and the ends of the film were removed by cutting the ends along the outside edges of the frame with use of a cutter. As a result, an independent and flexible film was obtained. Thereafter, the film was manually crushed and wadded up. However, no break was observed in the film. The film was placed in the frame again, overlaid with a mold release PET, and then sandwiched between stainless steel sheets. With use of a press molding machine, a laminate of the film and the mold release PET was heated at 140° C. for 5 minutes, and then press-molded at a pressure of 10 MPa for 5 minutes. As a result, the film having a thickness of 0.05 mm was restored completely.

Thus, it is found that the uncured or partially cured film obtained from the resin prepared in Example 5 also has, at the same time, thermoplastic remoldability and toughness during remolding, in addition to thermoplastic moldability and toughness during molding.

### Example 9

On a mold release PET (thickness of 50 μm), a mold release PET spacer which had a hole (thickness of 50 μm, 10-cm square) in the central part thereof was placed. The resin prepared in Example 6 was placed in the hole, and overlaid with a mold release PET. A laminate thus obtained was sandwiched between stainless steel sheets. With use of a press molding machine, the laminate was heated at 100° C. for 5 minutes, and then press-molded at a pressure of 10 MPa for 5 minutes. As a result, a film having a thickness of 0.05 mm was obtained. The obtained film was fixed in a frame, and the ends of the film were removed by cutting the ends along the outside edges of the frame with use of a cutter. As a result, an independent and flexible film was obtained. Thereafter, the film was manually crushed and wadded up. However, no break was observed in the film. The film was placed in the frame again, overlaid with a mold release PET, and then sandwiched between stainless steel sheets. With use of a press molding machine, a laminate of the film and the mold release PET was heated at 100° C. for 5 minutes, and then press-molded at a pressure of 10 MPa for 5 minutes. As a result, the film having a thickness of 0.05 mm was restored completely.

Thus, it is found that the uncured or partially cured film obtained from the resin prepared in Example 6 also has, at the same time, thermoplastic remoldability and toughness during remolding, in addition to thermoplastic moldability and toughness during molding.

### Comparative Example 3

On a mold release PET (thickness of 50 μm), a mold release PET spacer which had a hole (thickness of 50 μm, 10-cm square) in the central part thereof was placed. The resin prepared in Comparative Example 2 was placed in the hole, and overlaid with a mold release PET. A laminate thus obtained was sandwiched between stainless steel sheets. With use of a press molding machine, the laminate was heated at 100° C. for 5 minutes, and then press-molded at a pressure of 10 MPa for 5 minutes. As a result, a film having a thickness of 0.05 mm was obtained. The obtained film was fixed in a frame, and the ends of the film were removed by cutting the ends along the outside edges of the frame with use of a cutter. As a result, an independent and brittle film was obtained. Thereafter, the film was manually crushed and wadded up. As a result, the film was smashed. Smashed film pieces were placed in the frame again, overlaid with a mold release PET, and then sandwiched between stainless steel sheets. With use of a press molding machine, a laminate of the smashed film pieces and the mold release PET was heated at 100° C. for 5 minutes, and then press-molded at a pressure of 10 MPa for 5 minutes. As a result, the film having a thickness of 0.05 mm was restored completely.

### Comparative Example 4

A method similar to that in Comparative Example 3 was carried out to obtain a film having a thickness of 0.05 mm, except that, with use of a press molding machine, heating was carried out at 160° C. for 5 minutes and then press molding was carried out at a pressure of 10 MPa for 5 minutes. The obtained film was fixed in a frame, and the ends of the film were removed by cutting the ends along the outside edges of the frame with use of a cutter. As a result, an independent and flexible film was obtained. Thereafter, the film was manually crushed and wadded up. However, no break was observed in the film. The film was placed in the frame again, overlaid with a mold release PET, and then sandwiched between stainless steel sheets. With use of a press molding machine, a laminate of the film and the mold release PET was heated at 160° C. for 5 minutes, and then press-molded at a pressure of 10 MPa for 5 minutes. However, the film having a thickness of 0.05 mm was not restored completely.

TABLE 2

| | | | | | Comparative | Comparative |
|---|---|---|---|---|---|---|
| | | Example 7 | Example 8 | Example 9 | Example 3 | Example 4 |
| Resin | | JD11 | JD13 | JD19 | C6Bz1 | C6Bz2 |
| Press re | Heating temperature, | 160° C., 5 min → | 140° C., 5 min → | 100° C., 5 min → | 100° C., 5 min → | 160° C., 5 min → |
| molding | heating time → | 10 MPa, 5 min | 10 MPa, 5 min | 10 MPa, 5 min | 10 MPa, 5 min | 10 MPa, 5 min |
| condition | pressure, | | | | | |
| | pressurizing time | | | | | |
| Physical | Re moldability | Good | Good | Good | Good | Poor |
| properties | Toughness | Good | Good | Good | Poor | Good |
| | Repetitive | Good | Good | Good | Good | Poor |
| | thermoplasticity | | | | | |

### <Evaluation of Plasticity (Mandrel Test)>

### Example 10

With use of a hot press, the resin prepared in Example 6 was heated and pressurized (i) at 100° C. and 10 MPa for 30 minutes. As a result, a film (degree of cure of 5%) was obtained. The film molded with (i) was further heated in a convection oven (ii) at 140° C. for 2 hours (degree of cure of 22%), (iii) at 180° C. for 1 hour (degree of cure of 55%), and (iv) at 220° C. for 2 hours (degree of cure of 100%) without pressurizing. As a result, films (the degrees of cure are shown at the ends of the conditions) were obtained. In this manner, four films which differed from each other in degree of cure were prepared. Each film had a thickness of 0.125 mm.

Note that the degree of cure of each film was calculated from a ratio between the areas of curing exothermic peaks of the uncured resin and the film after heating which curing exothermic peaks were obtained from DSCs. With use of the Elcometer 1500 cylindrical mandrel set, the film was hung on each of cylindrical mandrels having different diameters (2 mm to 32 mm), and both ends of the film were pulled. In this case, the smallest diameter which did not cause a break was regarded as a bend radius (mm), and then the plasticity was evaluated. In a case where the film did not break even with use of a cylindrical mandrel having the smallest diameter (2 mm), the film was folded at an angle of 180 degrees (virtually, a diameter of 0 mm), and whether the film broke was evaluated. Table 3 shows results.

### Example 11

With use of a hot press, the resin prepared in Example 4 was heated and pressurized at 160° C. and 10 MPa for 30 minutes. In this manner, a film having a thickness of 0.125 mm was prepared. The obtained film was subjected to a mandrel test similar to that in Example 10, and plasticity was evaluated. Table 3 shows a result.

### Example 12

With use of a hot press, the resin prepared in Example 5 was heated and pressurized at 140° C. and 10 MPa for 30 minutes. In this manner, a film having a thickness of 0.125 mm was prepared. The obtained film was subjected to a mandrel test similar to that in Example 10, and plasticity was evaluated. Table 3 shows a result.

### Comparative Example 5

With use of a hot press, the resin prepared in Comparative Example 2 was heated and pressurized at 100° C. and 10 MPa for 30 minutes. In this manner, a film having a thickness of 0.125 mm was prepared. The obtained film was subjected to a mandrel test similar to that in Example 10. However, since the film had no independence, it was not possible to carry out measurement.

### Comparative Example 6

With use of a hot press, the resin prepared in Comparative Example 2 was heated and pressurized at 160° C. and 10 MPa for 30 minutes. In this manner, a film having a thickness of 0.125 mm was prepared. The obtained film was subjected to a mandrel test similar to that in Example 10, and plasticity was evaluated. Table 3 shows a result.

TABLE 3

| | Example 10 | | | |
|---|---|---|---|---|
| Resin | JD19 | | | |
| Film curing condition | (i) 100° C., 30 min | (ii) 140° C., 2 h | (iii) 180° C., 1 h | (iv) 220° C., 2 h |
| Degree of cure (%) | 5 | 22 | 55 | 100 |
| Mandrel test, bend | 2 mm | 2 mm | 2 mm | 2 mm |
| radius (mm) | | | | |
| 180 degree folding test | Good | Good | Good | Poor |

| | | | |
|---|---|---|---|
| | | Comparative | Comparative |
| Example 11 | Example 12 | Example 5 | Example 6 |

| | | | |
|---|---|---|---|
| Resin | JD11 | JD13 | C6Bz2 |

| | | | | |
|---|---|---|---|---|
| Film curing condition | 160° C., 30 min | 140° C., 30 min | 100° C., 30 min | 160° C., 30 min |
| Degree of cure (%) | not more than | not more than | not more than | not more than |
| | 99% | 99% | 99% | 99% |
| Mandrel test, bend | 2 mm | 2 mm | could not be | 4 mm |
| radius (mm) | | | measured | |
| 180 degree folding test | Good | Good | could not be | Poor |
| | | | measured | |

It is found from Table 3 that, since a break, a crack, and the like did not appear in the uncured or partially cured film obtained from the resin in each of Examples 4 and 5 even in the plasticity test (mandrel test) with use of a cylinder having a diameter of 2 mm, the uncured or partially cured film had excellent toughness. Moreover, it is found that, since a break, a crack, and the like did not appear even in the 180 degree folding test without use of a cylinder, the uncured or partially cured film had extremely excellent toughness.

Similarly, it is found that, since, even in the plasticity test (mandrel test) with use of a cylinder having a diameter of 2 mm, a break, a crack, and the like did not appear in the films which were obtained from the resin in Example 6 and which had degrees of cure of 5% to 100%, the films had excellent toughness. Moreover, it is found that, since, even in the 180 degree folding test without use of a cylinder, a break, a crack, and the like did not appear in the partially cured films which had degrees of cure of 5% to 55%, the partially cured films had extremely excellent toughness.

### <Change in Dynamic Viscoelasticity (DMA) Curve by Degree of Cure>

### Example 13

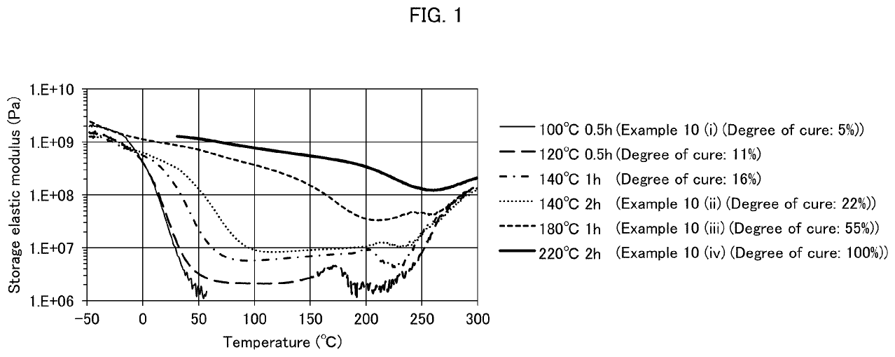

A DMA test as described in “(4) Glass transition temperature (Tg)” was carried out with respect to the films which were prepared under the conditions (i) to (iv) in Example 10 and films which were prepared under curing conditions of heating at 120° C. for 0.5 hours (degree of cure of 11%) and heating at 140° C. for 1 hour (degree of cure of 16%), and changes in DMA curves were measured. A temperature (° C.) was plotted on a horizontal axis, and a storage elastic modulus (Pa) was plotted on a vertical axis. Measurement results are shown in FIG. 1.

As the degree of cure increased, the Tg shifted to a high temperature side, and an increase in elastic modulus in a rubbery plateau was observed.

Moreover, in each of the films having degrees of cure of 5% to 55%, a rubbery plateau of an order of 10⁶ to 10⁷ Pa·s was observed. Thus, it is found that, since heating the resin at a temperature which corresponds to the rubbery plateau facilitates remolding of the resin, the degree of cure preferably falls within the range of 5% to 55%.

### <Preparation and Evaluation of Carbon Fiber Composite Material (CFRP)>

### (1) Amount of Bleeding-Out Resin (% by Weight)

The weight of the resin which bled out from CFRP after heat-curing was measured, and a ratio of the weight of the resin which bled out from the CFRP to the total weight of the resin with which carbon fibers were impregnated before curing was calculated.

### (2) Void (90-Degree Fibers)

A 1-cm square piece was cut out from the central part of the CFRP having a plate shape with use of a diamond cutter, and was embedded in an epoxy resin. Next, a cross section which contained the CFRP (cross section perpendicular to a direction in which fibers extended) was exposed with use of a diamond cutter, and polished with use of a polishing device (MINITECH 223, manufactured by Presi). Thereafter, by observing the cross section with use of a digital microscope (VHX-200, manufactured by Keyence Corporation), the presence or absence of a void present in a 90-degree fiber section was evaluated. Note, here, that “a void present in a 90-degree fiber section” refers to a void present between fibers (a void surrounded by the fibers) on a cross section perpendicular to a direction in which fibers extend.

### (3) Void (Resin)

By a method similar to that in the above (2), the presence or absence of a void in a part of the cross section in which part only the resin was present was evaluated.

### (4) Discoloration of Resin

By a method similar to that in the above (2), the presence or absence of discoloration in the part of the cross section in which part only the resin was present was evaluated.

### (5) Storage Elastic Modulus (E′)

With use of a dynamic viscoelasticity measurement device (RSA-3, manufactured by TA Instruments), the storage elastic modulus E′ of the CFRP at a measurement frequency of 1 Hz and a measurement temperature of 50° C. was determined.

### (6) Glass Transition Temperature (Tg)

With use of a dynamic viscoelasticity measurement device (RSA-3, manufactured by TA Instruments), the glass transition temperature Tg of the CFRP was determined.

### (1. Method for Preparing Film)

### Example 14

On a mold release PET (thickness of 50 μm), a mold release PET spacer which had a hole (thickness of 50 μm, 8-cm or 10-cm square) in the central part thereof was placed. The resin prepared in Example 6 was placed in the hole, and overlaid with a mold release PET. A laminate thus obtained was sandwiched between stainless steel sheets. With use of a press molding machine, the laminate was heated at 60° C. for 5 minutes, and then press-molded at a pressure of 10 MPa for 10 minutes. As a result, a film having a thickness of 0.05 mm was obtained.

### (2. Method for Preparing Prepreg)

The following shows the types of carbon fiber plain weave materials used to prepare prepregs.
PAN-based carbon fibers manufactured by Mitsubishi Chemical Corporation (product name: TR3110 M, fiber weight: 200 g/m², density: 1.79 g/cm³)
PAN-based carbon fibers manufactured by Toray Industries, Inc. (product name: C06343B, fiber weight: 198 g/m², density: 1.76 g/cm³)

Note that a sizing agent was removed from the PAN-based carbon fibers manufactured by Toray Industries, Inc., by heating the PAN-based carbon fibers at 300° C. for 1.5 hours in a convection oven.

### Example 15

The film prepared in Example 14 was overlaid on the top and back of a carbon fiber plain weave material (TR3110 M), and sandwiched between stainless steel sheets. With use of a press molding machine, a laminate of the film and the carbon fiber plain weave material was heated at 60° C. for 5 minutes, and then press-molded at a pressure of 1 MPa for 10 minutes. As a result, a prepreg having a thickness of 0.2 mm to 0.3 mm was obtained. Note that the film of 8-cm square was overlaid on the top of the carbon fiber plain weave material, and the film of 10-cm square was overlaid on the back of the carbon fiber plain weave material.

### Example 16

A prepreg having a thickness of 0.2 mm to 0.3 mm was obtained by the same method as that in Example 12, except that the type of a carbon fiber plain weave material was C06343B.

### (3. Method for Preparing CFRP)

### Example 17

Prepregs prepared in Example 15 were stacked to obtain a 10-layer prepreg. The obtained laminated prepreg was sandwiched between two PI films which were mold releasing films. Note that the sides (thickness parts) of the laminated prepreg were exposed from the PI films. The laminated prepreg sandwiched between the PI films was further sandwiched between stainless steel sheets. With use of a press molding machine, the laminated prepreg sandwiched between the PI films was (1) pressed at 60° C. and 1 MPa for 10 minutes, (2) heated to 100° C. and pressed at 1 MPa for 20 minutes, and then (3) heated to 220° C. and pressed at 1 MPa for 2 hours so as to be cured. In this manner, a plate-shaped CFRP having a thickness of approximately 2 mm was obtained. Table 4 shows results.

### Example 18

Prepregs prepared in Example 16 were stacked to obtain a 5-layer prepreg. The obtained laminated prepreg was covered with two PI films which were mold releasing films and which were 8 cm long and 25 cm wide. The covered laminated prepreg was further sandwiched between stainless steel sheets. With use of a press molding machine, the covered laminated prepreg was (1) pressed at 60° C. and 1 MPa for 10 minutes, (2) heated to 100° C. and pressed at 1 MPa for 20 minutes, and then (3) heated to 220° C. and pressed at 1 MPa for 2 hours so as to be cured. In this manner, a plate-shaped CFRP having a thickness of approximately 1 mm was obtained. Table 4 shows results.

### Example 19

Prepregs prepared in Example 16 were stacked to obtain a 5-layer prepreg. The obtained laminated prepreg was covered with two PI films which were mold releasing films and which were 8 cm long and 25 cm wide. The covered laminated prepreg was further sandwiched between stainless steel sheets. With use of a press molding machine, the covered laminated prepreg was (1) pressed at 60° C. and 1 MPa for 10 minutes and then (2) heated to 100° C. and pressed at 1 MPa for 20 minutes. The covered laminated prepreg was then taken out. Thereafter, the covered laminated prepreg was (3) heated at 220° C. for 2 hours in a vacuum oven so as to be cured. In this manner, a plate-shaped CFRP having a thickness of approximately 1 mm was obtained. Table 4 shows results.

### Example 20

Prepregs prepared in Example 16 were stacked to obtain a 5-layer prepreg. The obtained laminated prepreg was covered with two PI films which were mold releasing films and which were 8 cm long and 25 cm wide. The covered laminated prepreg was further sandwiched between stainless steel sheets. In a vacuum press molding machine, the covered laminated prepreg was (1) heated at 100° C. for 8 minutes (under an atmospheric pressure) and then (2) vacuum-pressed at 2 MPa for 22 minutes. The covered laminated prepreg was then taken out. Thereafter, the laminated prepreg was (3) heated to 220° C. and vacuum-pressed at 2 MPa for 2 hours so as to be cured. In this manner, a plate-shaped CFRP having a thickness of approximately 1 mm was obtained. Table 4 shows results.

### Example 21

Prepregs prepared in Example 16 were stacked to obtain a 5-layer prepreg. The obtained laminated prepreg was covered with two PI films which were mold releasing films and which were 8 cm long and 25 cm wide. The covered laminated prepreg was further sandwiched between stainless steel sheets. In a vacuum press molding machine, the covered laminated prepreg was (1) heated at 100° C. for 7 minutes (under an atmospheric pressure), (2) vacuum-pressed at 2 MPa for 23 minutes, and then (3) heated to 220° C. and vacuum-pressed at 2 MPa for 2 hours so as to be cured. In this manner, a plate-shaped CFRP having a thickness of approximately 1 mm was obtained. Table 4 shows results.

TABLE 4

| | | | Example 17 | Example 18 | Example 19 | Example 20 | Example 21 |
|---|---|---|---|---|---|---|---|
| Resin | | | JD19 | JD19 | JD19 | JD19 | JD19 |
| Prepreg | CF | | TR3110M | CO6343B | CO6343B | CO6343B | CO6343B |
| | Sizing agent | | Yes | No | No | No | No |
| Preparation | Number of stacked | | 10 | 5 | 5 | 5 | 5 |
| conditions | prepregs | | | | | | |
| | Processing | | Press | Press | Press → | Vacuum press | Vacuum press |
| | method | | | | Vacuum oven | | |
| | Covering with PI | | No | Yes | Yes | Yes | Yes |
| | Temperature/time/ | | 60° C./10 | 60° C./10 | 60° C./10 | 100° C./8 | 100° C./7 |
| | pressure | | min/1 MPa | min/1 MPa | min/1 MPa | min/0 MPa | min/0 MPa |
| | | | 100° C./20 | 100° C./20 | 100° C./20 | 100° C./22 | 100° C./23 |
| | | | min/1 MPa | min/1 MPa | min/1 MPa | min/2 MPa | min/2 MPa |
| | | | 220° C./2 | 220° C./2 | 220° C./2 | 220° C./2 | 220° C./2 |
| | | | h/1 MPa | h/1 MPa | h/? | h/2 MPa | h/2 MPa |
| | Taking out after | | No | No | Yes | Yes | No |
| | temperature | | | | | | |
| | increase | | | | | | |
| Physical | Amount of | | 27 | 12 | 0 | 0 | 0 |
| properties | bleeding-out resin | | | | | | |
| | (wt %) | | | | | | |
| | Void on | 90- | No | No | Yes | Yes | Yes (very few) |
| | cross | degree | | | | | |
| | section | fiber | | | | | |
| | | Resin | Yes | Yes | No | No | No |

| | | | | | |
|---|---|---|---|---|---|
| Discoloration of | Yes | Yes | No | No | No |
| resin | | | | | |
| E′ (DMA) @ 50° C. | 1.06E\hat{ }10 | 1.45E\hat{ }10 | 1.07E\hat{ }10 | 1.00E\hat{ }10 | 1.25E\hat{ }10 |
| Tg (DMA) ° C. | 238 | 254 | 225 | 234 | 231 |

As is clear from Table 4, the thermosetting resin for which Jeffamine D2000, which was the (poly)oxyalkylenediamine compound (C), and hexamethylenediamine, which was the aliphatic diamine compound (B), were used could be suitably used for CFRP.

Note that it is found, from Examples 19 to 21, that the sizing agent is preferably removed, from the viewpoint of preventing discoloration of the resin and a void between the resin and the resin. Moreover, in Examples 18 to 21, it was possible to reduce bleedout by covering with use of the PI films. It is inferred that, in Examples 19 to 21, use of the vacuum oven or the vacuum press molding machine contributed to suppression of a void between the resin and the resin. It is inferred that a void between the fibers can be suppressed by using the press molding machine or the vacuum press molding machine. As in Examples 17, 18, and 21, by heating the prepreg without taking out the prepreg from the press molding machine or the vacuum press molding machine, it was possible to further suppress a void between the fibers.

### INDUSTRIAL APPLICABILITY

The present disclosure can be used in the fields in which thermosetting resins are used.

1. A thermosetting resin which has, in a main chain, a benzoxazine ring structure represented by a general formula (I): 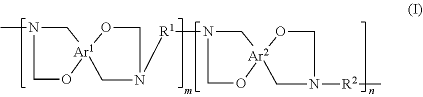
[wherein:
Ar¹ and Ar² each independently represent a tetravalent aromatic group that is derived from a bifunctional phenol compound (A), and may be identical to or different from each other;
n represents an integer of 0 or more;
in a case where n=0, R¹ represents a linear alkylene group that is derived from an aliphatic diamine compound (B) and that has 8 to 12 carbon atoms, and, in a case where n=1 or more, R¹ represents a linear alkylene group that is derived from the aliphatic diamine compound (B) and that has 6 to 12 carbon atoms;
R² represents a (poly)oxyalkylene group that is derived from a (poly)oxyalkylenediamine compound (C);
in the case where n=0, at least one of two termini of the main chain is a group that is derived from a monofunctional phenol compound (E) and that is represented by a general formula (II) below, and the two termini may be identical to or different from each other;
in the case where n=0, m represents an integer of 2 or more, and, in the case where n=1 or more, m represents an integer of 1 or more; and
a repeating unit indicated by m and a repeating unit indicated by n are repeated randomly, repeated as blocks, or copolymerized in an alternating manner], 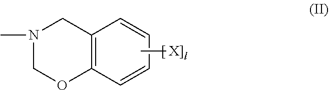
[wherein:
X represents a hydrogen atom or an organic group that has 1 to 20 carbon atoms; and
l represents an integer of 0 to 3].

2. The thermosetting resin as set forth in claim 1, wherein the bifunctional phenol compound (A) is at least one bifunctional phenol compound selected from the group consisting of 2,2-bis(4-hydroxyphenyl)propane, 1,1-bis(4-hydroxyphenyl)-1-phenylethane, 2,2-bis(4-hydroxyphenyl)hexafluoropropane, 2,2-bis(4-hydroxyphenyl)butane, bis(4-hydroxyphenyl)diphenylmethane, 2,2-bis(3-methyl-4-hydroxyphenyl)propane, bis(4-hydroxyphenyl)-2,2-dichloroethylene, 1,1-bis(4-hydroxyphenyl)ethane, bis(4-hydroxyphenyl)methane, 2,2-bis(4-hydroxy-3-isopropylphenyl)propane, 1,3-bis(2-(4-hydroxyphenyl)-2-propyl)benzene, bis(4-hydroxyphenyl)sulfone, 1,4-bis(2-(4-hydroxyphenyl)-2-propyl)benzene, 5,5′-(1-methylethylidene)-bis[1,1′-(bisphenyl)-2-ol]propane, 1,1-bis(4-hydroxyphenyl)-3,3,5-trimethylcyclohexane, and 1,1-bis(4-hydroxyphenyl)cyclohexane.

3. The thermosetting resin as set forth in claim 1, wherein the (poly)oxyalkylenediamine compound (C) has a (poly)oxyethylene group and/or a (poly)oxypropylene group.

4. The thermosetting resin as set forth in claim 1, wherein, in the general formula (I), a ratio between m and n is n/m=1/0.1 to 1/100.

5. A composition which comprises a thermosetting resin recited in claim 1.

6. An uncured molded product which is obtained by molding a thermosetting resin recited in claim 1.

7. The uncured molded product as set forth in claim 6, wherein a bend radius is not more than 2 mm in a mandrel test in conformity with JIS K-5600-5-1:1999.

8. A partially cured molded product which is obtained by partially curing a thermosetting resin recited in claim 1 and which has a degree of cure of 1% to 99%.

9. The partially cured molded product as set forth in claim 8, wherein a bend radius is not more than 2 mm in a mandrel test in conformity with JIS K-5600-5-1:1999.

10. A cured molded product which is obtained by curing a thermosetting resin recited in claim 1.

11. The cured molded product as set forth in claim 10, wherein a bend radius is not more than 2 mm in a mandrel test in conformity with JIS K-5600-5-1:1999.

12. A thermosetting resin which has a benzoxazine ring structure in a main chain, wherein
an uncured molded product that is obtained by molding the thermosetting resin and that has a degree of cure of less than 1% or a partially cured molded product that is obtained by curing the thermosetting resin and that has a degree of cure of 1% to 99% has thermoplastic remoldability and toughness,
the thermoplastic remoldability refers to a property in which, after the uncured molded product or the partially cured molded product is deformed in any shape, the uncured molded product or the partially cured molded product is restored to a shape before deformation, by heating at not higher than 200° C.,
the toughness refers to a property in which a break or a crack does not occur in the uncured molded product or the partially cured molded product before and after the heating, and
the uncured molded product or the partially cured molded product has repetitive thermoplasticity that is a property in which the thermoplastic remoldability and the toughness are maintained even in a case where the deformation and the heating are carried out once or more.

13. A method for producing a thermosetting resin which has a benzoxazine ring structure in a main chain, comprising:
a step (s1) of reacting a bifunctional phenol compound (A), an aliphatic diamine compound (B), and an aldehyde compound (D);
optionally a step (s2) of reacting the bifunctional phenol compound (A), a (poly)oxyalkylenediamine compound (C), and the aldehyde compound (D); and
optionally a step (s3) of reacting a monofunctional phenol compound (E), wherein:
in a case where the method does not comprise the step (s2), the method comprises the step (s3);
in a case where the method comprises the step (s2), the aliphatic diamine compound (B) is an aliphatic diamine that has a linear alkylene group having 6 to 12 carbon atoms, and, in a case where the method does not comprise the step (s2), the aliphatic diamine compound (B) is an aliphatic diamine that has a linear alkylene group having 8 to 12 carbon atoms; and
the (poly)oxyalkylenediamine compound (C) has a (poly)oxyethylene group and/or a (poly)oxypropylene group.

14. The method as set forth in claim 13, wherein a ratio between the number of moles of the aliphatic diamine compound (B) and the number of moles of the (poly)oxyalkylenediamine compound (C) is the (poly)oxyalkylenediamine compound (C)/the aliphatic diamine compound (B)=1/0.1 to 1/100.
